(19) United States
(12) Patent Application Publication
(10) Pub. No.: US 2025/0131303 A1
(43) Pub. Date: Apr. 24, 2025

(54) Quantum Control System Architecture with Low-Latency Unstructured Control Flow

(71) Applicant: International Business Machines Corporation, Armonk, NY (US)

(72) Inventors: Thomas ALEXANDER, Halifax (CA); Scott M. WILLENBORG, Stewartville, MN (US); Marius HILLENBRAND, Boeblingen (DE); Jeremy T EKMAN, West Concord, MN (US); Thilo MAURER, Nufringen (DE)

(21) Appl. No.: 18/489,325

(22) Filed: Oct. 18, 2023

(51) Int. Cl. G06N 10/40

(52) U.S. Cl. CPC G06N 10/40

(57) ABSTRACT

Systems, computer program products and/or computer-implemented methods described herein relate to a quantum control system architecture with low-latency unstructured control-flow, e.g., including gapless waveform playback through remote invocation of control subsequences. A system can include a memory that stores computer executable components and a processor that executes the computer executable components, which can include an orchestration component that determines selected real-time control sequences for synchronized execution by qubit controllers and a synchronization component that communicates a control message to the qubit controllers, where the control message causes the qubit controllers to wait until a common action time and to execute the selected real-time control sequences at the common action time.

### TECHNICAL FIELD

The present disclosure generally relates to a quantum control system architecture, and more particularly to a quantum control system architecture that provides low-latency unstructured control flow during execution of a quantum circuit.

### BACKGROUND

While quantum computing can be conceptualized at a high level in terms of quantum gates and measurements applied to qubits, control systems for generating quantum gates and producing measurements generally do not operate in terms of applying gates directly to qubits in the same sense as applying a classical logic gate. Instead, these control systems can control qubits using waveform stimuli and/or other stimuli that are emitted from hardware controllers.

### SUMMARY

The following presents a summary to provide a basic understanding of one or more embodiments described herein. This summary is not intended to identify key or critical elements, and/or to delineate scope of particular embodiments or scope of claims. Its sole purpose is to present concepts in a simplified form as a prelude to the more detailed description that is presented later. In one or more embodiments, systems, computer-implemented methods, apparatuses and/or computer program products described herein can provide a process to facilitate a quantum control system architecture with low-latency unstructured control flow, e.g., an unstructured control flow with gapless waveform playback through remote invocation of control subsequences.

In accordance with an embodiment, a system can include a memory that stores computer executable components and a processor that executes the computer executable components stored in the memory. The computer executable components can include an orchestration component that determines selected real-time control sequences for synchronized execution by qubit controllers and a synchronization component that communicates a control message to the qubit controllers, where the control message causes the qubit controllers to wait until a common action time and to execute the selected real-time control sequences at the common action time. Benefits of the system can include, e.g., reduction in the amount of time qubits controlled via the qubit controllers are in an idle state, which can in turn reduce an amount of error associated with the qubits.

In embodiments, the control message utilized by the above system can include address data indicative of locations within block tables associated with the qubit controllers at which instructions associated with the real-time control sequences are stored. Formatting the control message in this manner can have the technical effect of enabling the qubit controllers to refer to pre-written control sequences during execution, reducing messaging latency associated with quantum circuit execution. In further embodiments, the address data can include indexes of entries in jump tables associated with the qubit controllers, where the entries in the jump tables facilitate redirection to the locations within the block tables. The jump table indexes can have the technical effect of further reducing messaging latency associated with quantum circuit execution, e.g., by facilitating communication of a comparatively short reference to a group of instructions rather than the instructions themselves.

In embodiments, the selected real-time control sequences can include first instructions that facilitate applying a stimulus to an associated qubit and second instructions that facilitate measuring a property of the associated qubit resulting from application of the stimulus. Benefits of real-time control sequences structured in this manner can include, e.g., improved control over the operation of an underlying qubit on a per-operation basis.

In embodiments, the selected real-time control sequences can be first selected real-time control sequences, the common action time can be a first common action time, the control message can be a first control message, the orchestration component can further determine second selected real-time control sequences for synchronized execution by the qubit controllers at a second common action time, the second common action time being a completion time of the first selected real-time control sequences, and the synchronization component can further communicate a second control message to the qubit controllers, where the second control message causes the qubit controllers to execute the second selected real-time control sequences at the second common action time. These operations can have the technical effect of removing or significantly reducing the amount of time a qubit is idle between control sequences, which can in turn reduce system errors as described above.

In embodiments, the common action time can be based on a shared clock signal utilized by the system and the qubit controllers. This can have the benefit of, e.g., enabling synchronization between the system and the qubit controllers without maintaining separate clock sources at each device.

In accordance with another embodiment, a computer-implemented method can include determining, by a system operatively coupled to a processor, selected real-time control sequences for synchronized execution by qubit controllers and communicating, by the system, a control message to the qubit controllers, where the control message causes the qubit controllers to wait until a common action time and to execute the selected real-time control sequences at the common action time. Benefits of the computer-implemented method can include, e.g., reduction in the amount of time qubits controlled via the qubit controllers are in an idle state, which can in turn reduce an amount of error associated with the qubits.

In embodiments, the control message can include address data indicative of locations within block tables associated with the qubit controllers at which instructions associated with the selected real-time control sequences are stored. Formatting the control message in this manner can have the technical effect of enabling the qubit controllers to refer to pre-written control sequences during execution, reducing messaging latency associated with quantum circuit execution. In further embodiments, the address data can include indexes of entries in jump tables associated with the qubit controllers, where the entries in the jump tables facilitate redirection to the locations within the block tables. The jump table indexes can have the technical effect of further reducing messaging latency associated with quantum circuit execution, e.g., by facilitating communication of a comparatively short reference to a group of instructions rather than the instructions themselves.

In embodiments, the selected real-time control sequences can be first selected real-time control sequences, the common action time can be a first common action time, the control message can be a first control message, and the computer-implemented method can further include determining, by the system, second selected real-time control sequences for synchronized execution by the qubit controllers at a second common action time, the second common action time being a completion time of the first selected real-time control sequences, and communicating, by the system, a second control message to the qubit controllers, where the second control message causes the qubit controllers to execute the second selected real-time control sequences at the second common action time. These operations can have the technical effect of removing or significantly reducing the amount of time a qubit is idle between control sequences, which can in turn reduce system errors as described above.

In embodiments, the common action time can be based on a shared clock signal utilized by the system and the qubit controllers. This can have the benefit of, e.g., enabling synchronization between the system and the qubit controllers without maintaining separate clock sources at each device.

In accordance with still another embodiment, a computer program product, facilitating a process to provide low-latency unstructured control flow in a quantum computer, can include a computer readable storage medium on which program instructions are stored. The program instructions can be executable by a processor to cause the processor to determine, by the processor, selected real-time control sequences for synchronized execution by qubit controllers and communicate, by the processor, a control message to the qubit controllers, where the control message causes the qubit controllers to wait until a common action time and to execute the selected real-time control sequences at the common action time. Benefits of the computer program product can include, e.g., reduction in the amount of time qubits controlled via the qubit controllers are in an idle state, which can in turn reduce an amount of error associated with the qubits.

In embodiments, the control message can include address data indicative of locations within block tables associated with the qubit controllers at which instructions associated with the selected real-time control sequences are stored. Formatting the control message in this manner can have the technical effect of enabling the qubit controllers to refer to pre-written control sequences during execution, reducing messaging latency associated with quantum circuit execution. In further embodiments, the address data can include indexes of entries in jump tables associated with the qubit controllers, where the entries in the jump tables facilitate redirection to the locations within the block tables. The jump table indexes can have the technical effect of further reducing messaging latency associated with quantum circuit execution, e.g., by facilitating communication of a comparatively short reference to a group of instructions rather than the instructions themselves.

In embodiments, the selected real-time control sequences can be first selected real-time control sequences, the common action time can be a first common action time, the control message can be a first control message, and the program instructions can further be operable to cause the processor to determine, by the processor, second selected real-time control sequences for synchronized execution by the qubit controllers at a second common action time, the second common action time being a completion time of the first selected real-time control sequences, and communicate, by the processor, a second control message to the qubit controllers, where the second control message causes the qubit controllers to execute the second selected real-time control sequences at the second common action time. These operations can have the technical effect of removing or significantly reducing the amount of time a qubit is idle between control sequences, which can in turn reduce system errors as described above.

In embodiments, the common action time can be based on a shared clock signal utilized by the system and the qubit controllers. This can have the benefit of, e.g., enabling synchronization between the system and the qubit controllers without maintaining separate clock sources at each device.

In accordance with a further embodiment, a system can include a memory that stores computer executable components and a processor that executes the computer executable components stored in the memory. The computer executable components can include a staging component that locates a real-time qubit control sequence within a block table associated with the system based on addressing information provided in a message received from a remote controller device at a first time and a control component that executes the real-time qubit control sequence on quantum hardware at a second time given by the message, where the second time is after the first time, and where the first time and the second time are based on a common clock signal that is common to the system and the remote controller device. Benefits of the system can include, e.g., enabling the system to act in synchronization with other systems at the same time (e.g., at the second time), which can reduce qubit error proportional to the amount of time a qubit controlled by the system is in an idle state. Benefits of the system can further include, e.g., enabling synchronization between the system and the remote controller device without maintaining separate clock sources at each device.

In embodiments, the addressing information can include an index of an entry of a jump table associated with the system, the entry of the jump table indicating a location of the real-time qubit control sequence within the block table. The jump table indexes can have the technical effect of further reducing messaging latency associated with quantum circuit execution, e.g., by facilitating communication of a comparatively short reference to a group of instructions rather than the instructions themselves.

In embodiments, the real-time qubit control sequence can include instructions that facilitate queueing a signal communication sequence, the signal communication sequence including applying a stimulus to a qubit associated with the quantum hardware and measuring a property of the qubit resulting from application of the stimulus. Benefits of real-time control sequences structured in this manner can include, e.g., improved control over the operation of an underlying qubit on a per-operation basis.

In embodiments, the computer executable components can further include a reporting component that transmits information relating to the property of the qubit resulting from the application of the stimulus to the remote controller device. The reporting component can have the technical effect of enabling the remote controller device to make decisions regarding subsequent control sequences in real time, which can enable the remote controller device to schedule control sequences for execution by the system in a gapless manner.

In embodiments, the real-time qubit control sequence can be a first real-time qubit control sequence, the addressing information can be first addressing information, the message can be a first message, the staging component can locate a second real-time qubit control sequence within the block table based on second addressing information provided in a second message received from the remote controller device, and the control component can execute the second real-time qubit control sequence on the associated quantum hardware at a third time given by the second message, the third time being a time at which the control component completes execution of the first real-time qubit control sequence. These operations can have the technical effect of removing or significantly reducing the amount of time a qubit is idle between control sequences, which can in turn reduce system errors as described above.

In accordance with yet another embodiment, a computer-implemented method can include locating, by a system operatively coupled to a processor, a real-time qubit control sequence within a block table associated with the system based on addressing information provided in a message received from a remote controller device at a first time and executing, by the system, the real-time qubit control sequence on quantum hardware at a second time given by the message, where the second time is after the first time, and where the first time and the second time are based on a common clock signal that is common to the system and the remote controller device. Benefits of the computer-implemented method can include, e.g., enabling the system to act in synchronization with other systems at the same time (e.g., at the second time), which can reduce qubit error proportional to the amount of time a qubit controlled by the system is in an idle state. Benefits of the computer-implemented method can further include, e.g., enabling synchronization between the system and the remote controller device without maintaining separate clock sources at each device.

In embodiments, the real-time qubit control sequence can include instructions that facilitate queueing a signal communication sequence, the signal communication sequence including applying a stimulus to a qubit associated with the quantum hardware and measuring a property of the qubit resulting from application of the stimulus. Benefits of real-time control sequences structured in this manner can include, e.g., improved control over the operation of an underlying qubit on a per-operation basis.

In embodiments, the computer-implemented method can further include transmitting, by the system, information relating to the property of the qubit resulting from the application of the stimulus to the remote controller device. These operations can have the technical effect of enabling the remote controller device to make decisions regarding subsequent control sequences in real time, which can enable the remote controller device to schedule control sequences for execution by the system in a gapless manner.

In embodiments, the real-time qubit control sequence can be a first real-time qubit control sequence, the addressing information can be first addressing information, the message can be a first message, and the computer-implemented method can further include locating, by the system, a second real-time qubit control sequence within the block table based on second addressing information provided in a second message received from the remote controller device and executing, by the system, the second real-time qubit control sequence on the associated quantum hardware at a third time given by the second message, the third time being a time at which the control component completes execution of the first real-time qubit control sequence. These operations can have the technical effect of removing or significantly reducing the amount of time a qubit is idle between control sequences, which can in turn reduce system errors as described above.

### DESCRIPTION OF THE DRAWINGS

FIG. 1 is a block diagram of an example, non-limiting system that can provide a quantum control system architecture with low-latency unstructured control flow in accordance with one or more embodiments described herein.

FIG. 2 illustrates a non-limiting quantum system that can be employed by the non-limiting system of FIG. 1 in accordance with one or more embodiments described herein.

FIG. 3 illustrates example quantum programs that can be utilized by the non-limiting system of FIG. 1 in accordance with one or more embodiments described herein.

FIG. 4 is a block diagram of an additional example, non-limiting system that can provide a quantum control system architecture with low-latency unstructured control flow in accordance with one or more embodiments described herein.

FIG. 5 is a block diagram of still another example, non-limiting system that can provide a quantum control system architecture with low-latency unstructured control flow in accordance with one or more embodiments described herein.

FIG. 6 is a simplified block diagram of an example, non-limiting quantum control system architecture in which the non-limiting systems of FIGS. 1, 4, and/or 5 can operate in accordance with one or more embodiments described herein.

FIG. 7 illustrates an example quantum program control flow that can be utilized by the non-limiting systems of FIGS. 1, 4, and/or 5 in accordance with one or more embodiments described herein.

FIG. 8 is a simplified block diagram of an example, non-limiting qubit controller that can operate according to the quantum program control flow of FIG. 7 in accordance with one or more embodiments described herein.

FIG. 9 illustrates example instruction execution timing that can be facilitated by the non-limiting systems of FIGS. 1, 4, and/or 5 in accordance with one or more embodiments described herein.

FIG. 10 is a flow diagram of one or more processes that can be performed by the non-limiting system of FIG. 1 in accordance with one or more embodiments described herein.

FIG. 11 is a flow diagram of one or more processes that can be performed by the non-limiting system of FIG. 5 in accordance with one or more embodiments described herein.

FIG. 12 is a block diagram of example, non-limiting classical computer environment in accordance with one or more embodiments described herein.

FIGS. 13A-13B are block diagrams of an example, non-limiting hybrid quantum-classical computer environment in accordance with one or more embodiments described herein.

### DETAILED DESCRIPTION

The following detailed description is merely illustrative and is not intended to limit embodiments and/or application or utilization of embodiments. Furthermore, there is no intention to be bound by any expressed or implied information presented in the preceding Summary section, or in the Detailed Description section. One or more embodiments are now described with reference to the drawings, wherein like reference numerals are utilized to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

Respective qubits associated with a quantum computing system can utilize their own unique sets of stimuli to implement quantum gates and/or measurements, which can in turn result in a quantum system including many different types of hardware controllers. For instance, a quantum system can include one or more hardware controllers per qubit to facilitate implementation of a quantum program from respective associated qubits. Because many different components can be used for control in a quantum system, it is desirable to orchestrate these components to emit the correct stimuli at the correct time, e.g., based on defined calibrations, to implement a given quantum program.

By way of example, it is generally not sufficient to simply queue all of the stimuli for a quantum program ahead of time because actions that are taken in connection with a quantum program often depend on the results of previous measurements. Accordingly, it is desirable to decide the next set of gates and/or measurements to be performed, as well as the stimuli utilized for implementing those gates and/or measurements, based on the results of a previous gate or measurement. As used herein, the terms “control flow” and “quantum control flow” refer to the process of implementing quantum gates and/or performing qubit measurements in sequence based on results of prior gates and/or measurements. This process can also or alternatively be referred to as “feedforward” or “feedback” control.

A technical problem of current quantum systems involves errors that can accumulate in a quantum program due to qubit decoherence. For instance, if a qubit of a quantum system is allowed to be idle (e.g., without a stimulus being applied to the qubit), the quantum system can at least partially lose control over the qubit, which can result in the system being unable to perform the appropriate gates and/or measurements for techniques such as dynamical decoupling that enable the system to undo error that accumulates while the qubit is idle. Implementations described herein can provide a solution to this problem by facilitating low-latency control flow in a programmable manner, such that a quantum system can continuously send stimuli even while making decisions that impact future program operations.

In addition, current quantum systems do not provide the ability to have hard real-time control over all qubit instructions at all points in time during circuit execution. Instead, current approaches prevent emitting pulses while making control flow decisions. This can, in turn, increase system latency, prevent the use of techniques such as dynamical decoupling, and contribute to the backlog problem in quantum error correction. To these ends, it would be desirable to efficiently choose from one of many possible sequences of gates based on a computation applied to measurement results. Moreover, it would be desirable to do so via a solution that is both efficient (e.g., in terms of speed) and works well with large numbers of qubits, general computations, and arbitrary control flow.

To the furtherance of the above and/or related ends, implementations described herein can facilitate dynamic selection of a block to execute in hardware at a specific time in a heterogeneous distributed quantum control system. Implementations described herein can further efficiently branch and invoke the selected block in each individual qubit controller at a specific time. As a result, implementations described herein can provide gapless control flow, e.g., by ensuring that there are no gaps in waveform playback and that continuous timing control is maintained even with arbitrary decisions.

As used herein, the term “data” can comprise metadata.

As used herein, the terms “entity,” “requesting entity,” and “user entity” can refer to a machine, device, component, hardware, software, smart device, party, organization, individual and/or human.

### DESCRIPTION

One or more embodiments are now described with reference to the drawings, where like referenced numerals are used to refer to like elements throughout. In the following description, for purposes of explanation, numerous specific details are set forth in order to provide a more thorough understanding of the one or more embodiments. It is evident in various cases, however, that the one or more embodiments can be practiced without these specific details.

Further, it should be appreciated that the embodiments depicted in one or more figures described herein are for illustration only, and as such, the architecture of embodiments is not limited to the systems, devices and/or components depicted therein, nor to any particular order, connection and/or coupling of systems, devices and/or components depicted therein.

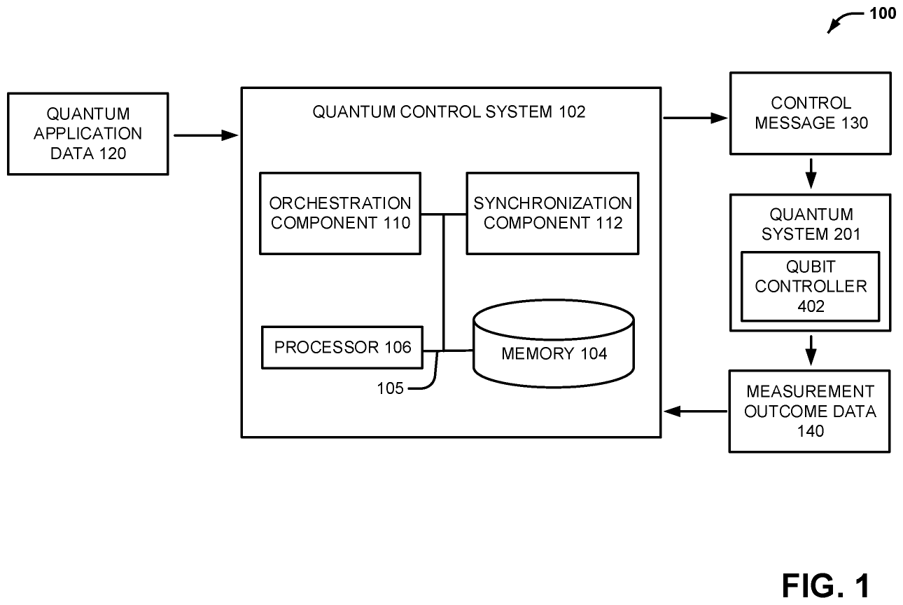

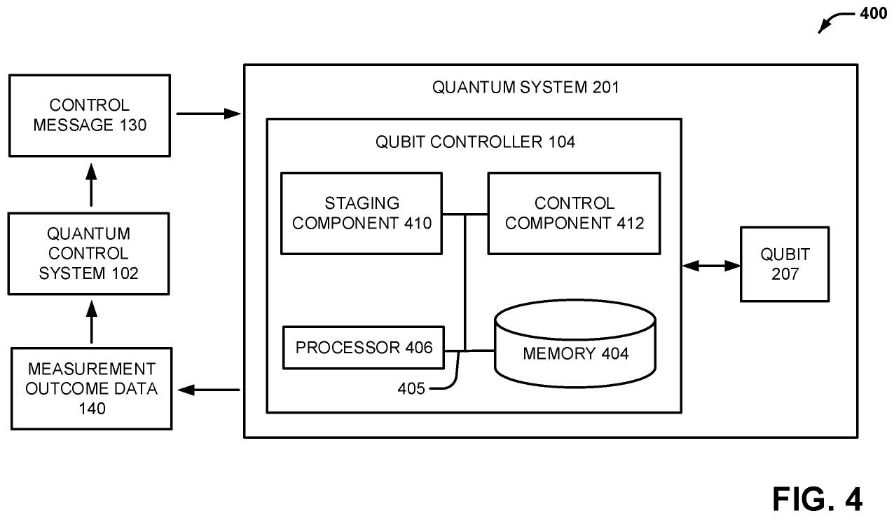

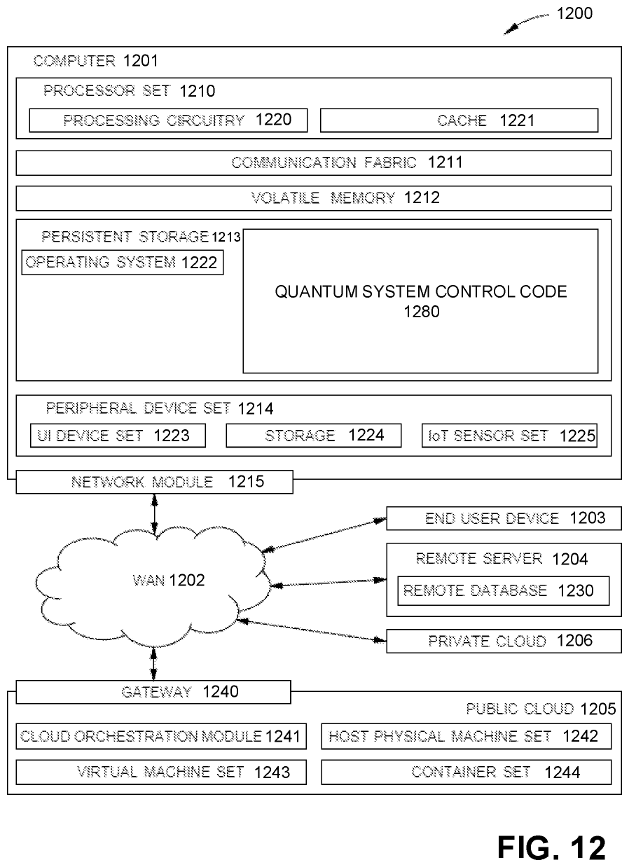

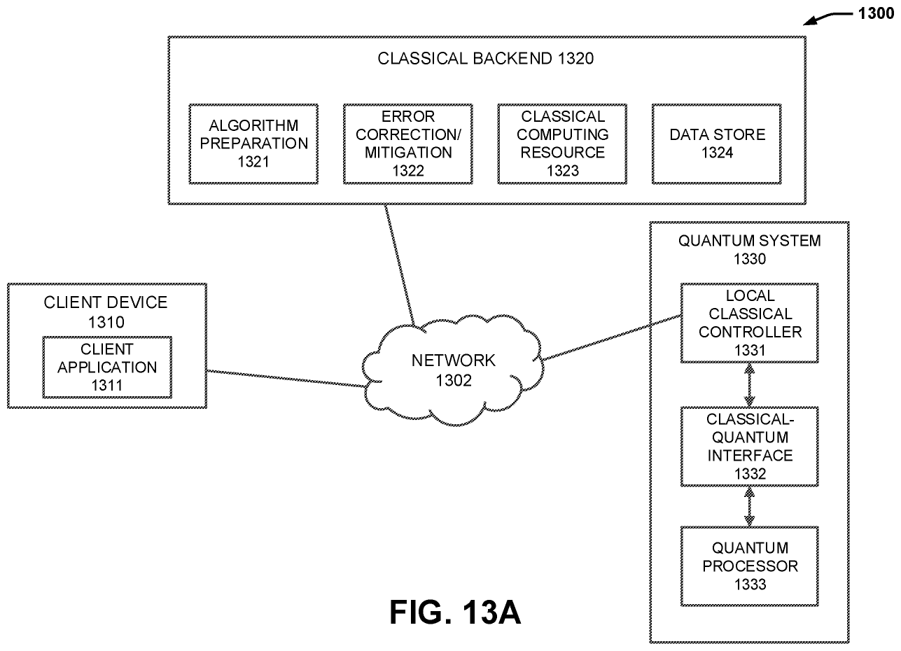

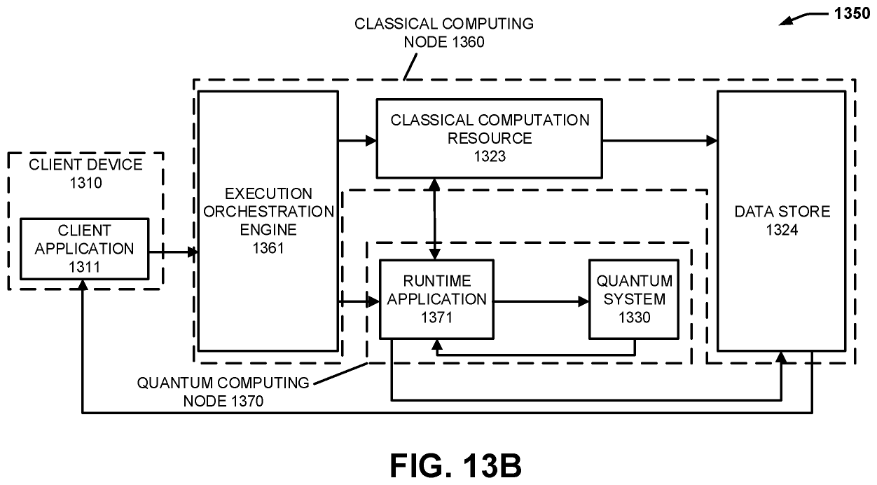

For example, in one or more embodiments, the non-limiting systems 100, 400 and/or 500 illustrated at FIGS. 1, 4 and 5, and/or systems thereof, can further comprise one or more computer and/or computing-based elements described herein with reference to a computing environment, such as the classical computing environment 1200 illustrated at FIG. 12 or the hybrid quantum-classical computing environment 1300 illustrated at FIGS. 13A-13B. In one or more described embodiments, computer and/or computing-based elements can be used in connection with implementing one or more of the systems, devices, components and/or computer-implemented operations shown and/or described in connection with FIGS. 1, 4 and/or 5, and/or with other figures described herein.

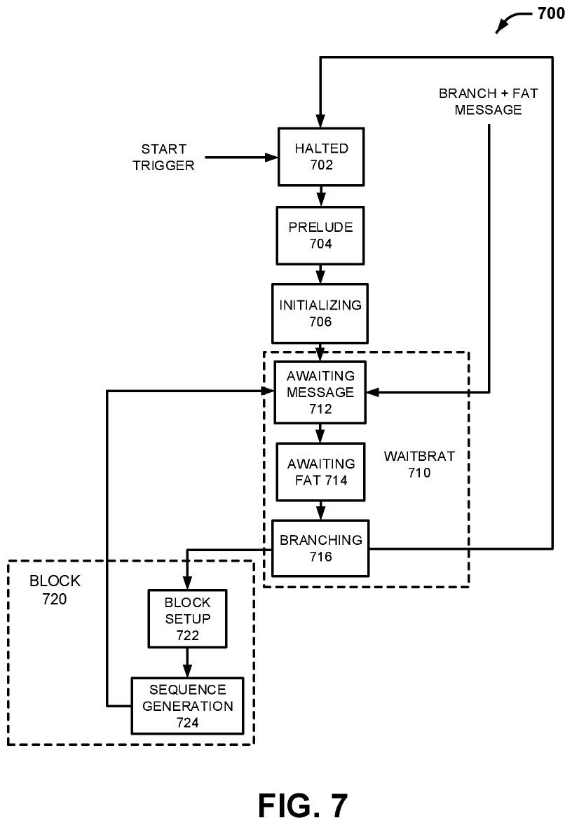

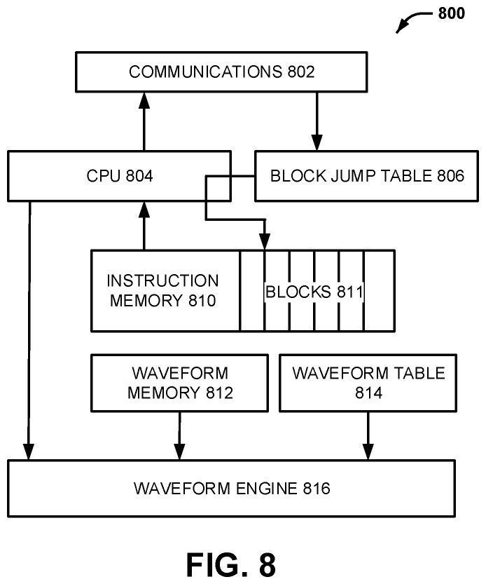

Turning now in particular to the figures, and first to FIG. 1, illustrated is a block diagram of an example, non-limiting system 100 that can facilitate a quantum control system architecture with low-latency unstructured control flow. The quantum control system 102 can comprise at least a memory 104, bus 105, processor 106, orchestration component 110, and synchronization component 122. Using these components and the quantum system 201, the quantum control system 102 can select real-time control sequences for synchronized execution by qubit controllers 402 associated with a quantum system 201, e.g., based on a control message 130 communicated from the quantum control system 102 to the qubit controllers 402. The control message 130 provided by the quantum control system 102 can cause the qubit controllers 402 to wait until a common action time and to execute the selected real-time control sequences at the common action time. Execution of the real-time control sequences by the qubit controllers 402 can cause the quantum system 201 to produce measurement outcome data 140, which can be provided back to the quantum control system 102 for further decision making, as will be further described below, e.g., with respect to FIGS. 7-8. As noted above, the real-time control sequences and control messaging provided by the quantum control system 102 can facilitate synchronized operation of multiple qubit controllers 402, potentially across multiple distinct devices, resulting in improved time efficiency in executing quantum programs as well as reduced qubit decoherence and/or errors associated with qubits being allowed to remain in an idle state.

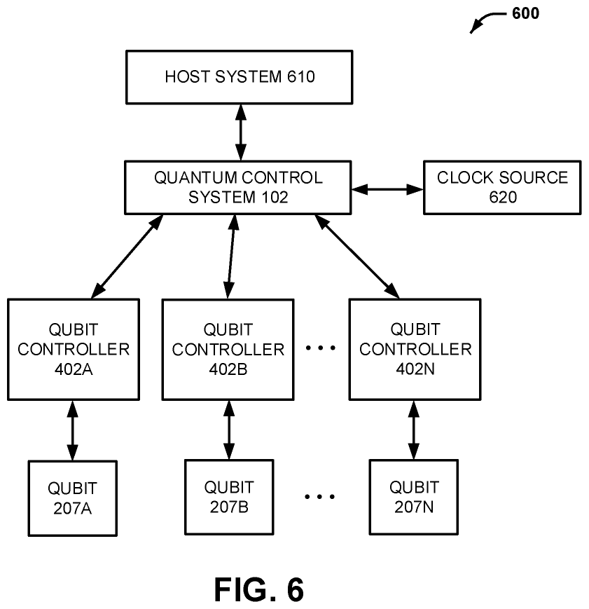

While only one qubit controller 402 is shown in FIG. 1 for simplicity of illustration, it is noted that the quantum system 201 can be associated with any suitable number of qubit controllers 402. An example of a system including multiple qubit controllers 402 is described in further detail below with respect to FIG. 6.

One or more communications between one or more components of the non-limiting system 100 can be provided by wired and/or wireless means including, but not limited to, employing a cellular network, a wide area network (WAN) (e.g., the Internet), and/or a local area network (LAN). Suitable wired or wireless technologies for supporting the communications can include, without being limited to, wireless fidelity (Wi-Fi), global system for mobile communications (GSM), universal mobile telecommunications system (UMTS), worldwide interoperability for microwave access (WiMAX), enhanced general packet radio service (enhanced GPRS), third generation partnership project (3GPP) long term evolution (LTE), third generation partnership project 2 (3GPP2) ultra-mobile broadband (UMB), high speed packet access (HSPA), Zigbee and other 802.XX wireless technologies and/or legacy telecommunication technologies, BLUETOOTH®, Session Initiation Protocol (SIP), ZIGBEE®, RF4CE protocol, WirelessHART protocol, 6LoWPAN (Ipv6 over Low power Wireless Area Networks), Z-Wave, an advanced and/or adaptive network technology (ANT), an ultra-wideband (UWB) standard protocol and/or other proprietary and/or non-proprietary communication protocols.

The quantum control system 102 can be associated with, such as accessible via, a cloud computing environment.

Discussion next turns briefly to the processor 106, memory 104 and bus 105 of the quantum control system 102. For example, in one or more embodiments, the quantum control system 102 can comprise the processor 106 (e.g., computer processing unit, microprocessor, classical processor, quantum processor and/or like processor). In one or more embodiments, a component associated with the quantum control system 102, as described herein with or without reference to the one or more figures of the one or more embodiments, can comprise one or more computer and/or machine readable, writable and/or executable components and/or instructions that can be executed by processor 106 to provide performance of one or more processes defined by such component and/or instruction. In one or more embodiments, the processor 106 can comprise the orchestration component 110 and/or synchronization component 112.

In one or more embodiments, the quantum control system 102 can comprise the computer-readable memory 104 that can be operably connected to the processor 106. The memory 104 can store computer-executable instructions that, upon execution by the processor 106, can cause the processor 106 and/or one or more other components of the quantum control system 102 (e.g., the orchestration component 110 and/or synchronization component 112) to perform one or more actions. In one or more embodiments, the memory 104 can store computer-executable components (e.g., the orchestration component 110 and/or synchronization component 112).

The quantum control system 102 and/or a component thereof as described herein, can be communicatively, electrically, operatively, optically and/or otherwise coupled to one another via a bus 105. Bus 105 can comprise one or more of a memory bus, memory controller, peripheral bus, external bus, local bus, quantum bus and/or another type of bus that can employ one or more bus architectures. One or more of these examples of bus 105 can be employed.

In one or more embodiments, the quantum control system 102 can be coupled (e.g., communicatively, electrically, operatively, optically and/or like function) to one or more external systems (e.g., a non-illustrated electrical output production system, one or more output targets and/or an output target controller), sources and/or devices (e.g., classical and/or quantum computing devices, communication devices and/or like devices), such as via a network. In one or more embodiments, one or more of the components of the quantum control system 102 and/or of the non-limiting system 100 can reside in the cloud, and/or can reside locally in a local computing environment (e.g., at a specified location).

In general, the non-limiting system 100 can employ any suitable method of communication (e.g., electronic, communicative, internet, infrared, fiber, etc.) to provide communication between the quantum control system 102 and the quantum system 201.

In addition to the processor 106 and/or memory 104 described above, the quantum control system 102 can comprise one or more computer and/or machine readable, writable and/or executable components and/or instructions that, when executed by processor 106, can provide performance of one or more operations defined by such component and/or instruction.

Discussion next turns to the additional components of the quantum control system 102 (e.g., the orchestration component 110 and synchronization component 112). The orchestration component 110 can determine selected real-time control sequences for synchronized execution by qubit controllers 402, e.g., based on quantum application data 120 associated with a quantum application (program, circuit, etc.), e.g., as provided via a client application or interface and/or by other appropriate means. The synchronization component 112 can then communicate a control message 130 to the qubit controllers 402, where the control message 130 causes the qubit controllers 402 to wait until a common action time, also referred to herein as a “future action time” or FAT, and to execute the selected real-time control sequences, and/or respective instructions or operations associated with those sequences, at the common action time.

By operating as described above, the quantum control system 102, via the orchestration component 110 and synchronization component 112, can facilitate selection of a block to execute, and then can instruct the qubit controllers 402 to branch at specific times to ensure that the qubit controllers 402 are executing at the same time.

A first reason for causing the qubit controllers 402 to branch at the same time involves the collection notion of a gate or measurement. In a typical quantum program, many different gates and/or measurements can be performed across respective qubits, and as a result these actions can be synchronized to be performed concurrently to avoid sequential control, e.g., where a first operation is performed on a first qubit, then a second operation is performed on a second qubit, etc. Additionally, because control of the quantum system 201 is heterogeneous, e.g., by splitting control among multiple qubit controllers 402, different controllers can emit different stimuli to the quantum hardware to implement a collective operation. If these controllers are misaligned in time, the stimuli emitted by those controllers will similarly be misaligned, which can cause the quantum system 201 to perform unexpectedly at the circuit level.

As a second reason for causing the qubit controllers 402 to branch at the same time, as decisions are made by the qubit controllers 402 during the control flow of a quantum program, decisions being performed by the qubit controllers 402 at separate times can cause the controllers to grow out of synchronization. Left uncorrected, this can result in qubit controllers 402 executing different parts of a given program. To prevent this, the quantum control system 102 can facilitate the use of hard real-time deadlines, where each instruction executes at a qubit controller 402 at a precise time as scheduled by the compiler, e.g., with respect to other instructions at other qubit controllers 402. By having this block branching done at a specific time, and then emitting waveforms of that block such that the qubit controllers 402 are synchronized, operation of the qubit controllers 402 can proceed deterministically until a subsequent control flow decision. This has the benefit of reducing the number of instances where communication occurs to those that impact block choice, as well as the benefit of ensuring timing synchronization (e.g., via a shared clock used by the qubit controllers 402) until the issuance of a subsequent instruction.

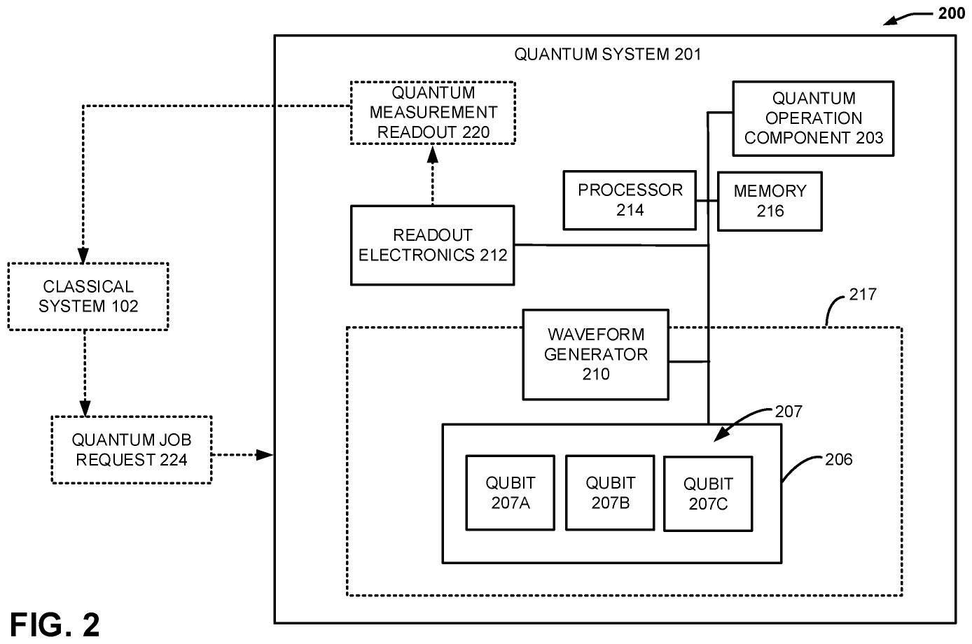

Turning to FIG. 2, one or more embodiments described herein can include one or more devices, systems and/or apparatuses that can facilitate a quantum control system architecture with low-latency unstructured control flow. Accordingly, at FIG. 2, illustrated is a block diagram of an example, non-limiting system 200 that can at least partially facilitate such an architecture.

As illustrated at FIG. 2, the non-limiting system 200 can comprise a quantum system 201 that can be employed with or separate from the classical system 102. Generally, the quantum system 201 (e.g., quantum computer system, superconducting quantum computer system and/or the like) can employ quantum algorithms and/or quantum circuitry, including computing components and/or devices, to perform quantum operations and/or functions on input data to produce results that can be output to an entity. The quantum circuitry can comprise quantum bits (qubits), such as multi-bit qubits, physical circuit level components, high level components and/or functions. The quantum circuitry can comprise physical pulses that can be structured (e.g., arranged and/or designed) to perform desired quantum functions and/or computations on data (e.g., input data and/or intermediate data derived from input data) to produce one or more quantum results as an output. The quantum results, e.g., quantum measurement readout 220, can be responsive to the quantum job request 224 and associated input data and can be based at least in part on the input data, quantum functions and/or quantum computations.

In one or more embodiments, the quantum system 201 can comprise components, such as a quantum operation component 203, a quantum processor 206, pulse component 210 (e.g., a waveform generator) and/or a readout electronics 212 (e.g., readout component). In one or more other embodiments, the readout electronics 212 can be comprised at least partially by the classical system 102 and/or be external to the quantum system 201. The quantum processor 206 can comprise one or more, such as plural, qubits 207. Individual qubits 207A, 207B and 207C, for example, can be fixed frequency and/or single junction qubits, such as transmon qubits.

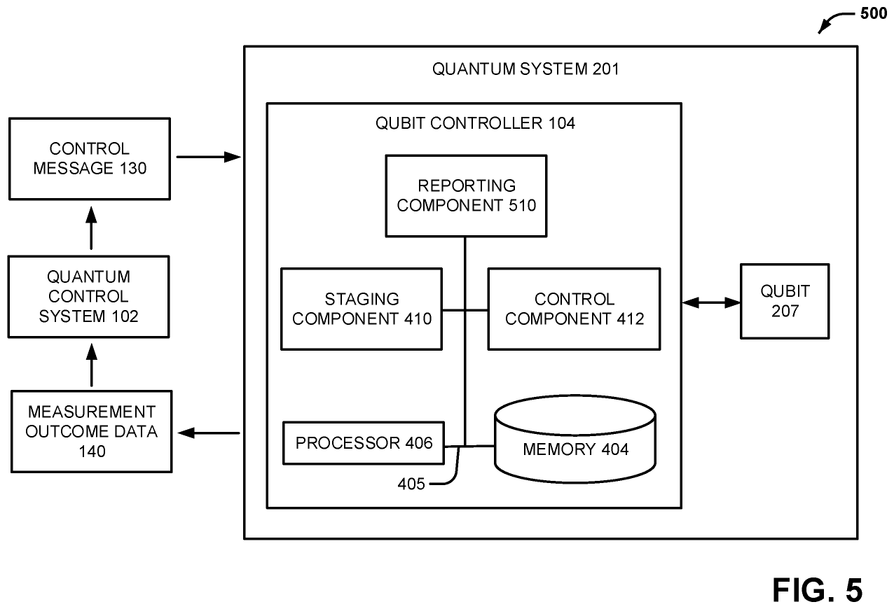

In one or more embodiments, a memory 216 and/or processor 214 can be associated with the quantum operation component 203, where suitable. The processor 214 can be any suitable processor. The processor 214 can generate one or more instructions for controlling the one or more processes of the quantum operation component 203. In embodiments, the processor 214 and memory 216 can also be associated with sub-elements of the quantum system 201, such as qubit controllers 402, which will be described in further detail with respect to FIGS. 4-5.

The quantum operation component 203 can obtain (e.g., download, receive, search for and/or the like) a quantum job request 224 requesting execution of one or more quantum programs and/or a physical qubit layout. The quantum job request 224 can be provided in any suitable format, such as a text format, binary format and/or another suitable format. In one or more embodiments, the quantum job request 224 can be obtained by a component other than of the quantum system 201, such as a by a component of the classical system 102.

The quantum operation component 203 can determine mapping of one or more quantum logic circuits for executing a quantum program. In one or more embodiments, the quantum operation component 203 and/or quantum processor 206 can direct the waveform generator 210 to generate one or more pulses, tones, waveforms and/or the like to affect one or more qubits 207, such as in response to a quantum job request 224.

The waveform generator 210 can generally cause the quantum processor 206 to perform one or more quantum processes, calculations and/or measurements by creating a suitable electro-magnetic signal. For example, the waveform generator 210 can operate one or more qubit effectors, such as qubit oscillators, harmonic oscillators, pulse generators and/or the like to cause one or more pulses to stimulate and/or manipulate the state(s) of the one or more qubits 207 comprised by the quantum system 201.

The quantum processor 206 and a portion or all of the waveform generator 210 can be contained in a cryogenic environment, such as generated by a cryogenic environment 217, such as effected by a dilution refrigerator. Indeed, a signal can be generated by the waveform generator 210 to affect one or more of the plurality of qubits 207. Where the plurality of qubits 207 are superconducting qubits, cryogenic temperatures, such as about 4K or lower, can be employed for function of these physical qubits. Accordingly, one or more elements of the readout electronics 212 also can be constructed to perform at such cryogenic temperatures.

The readout electronics 212, or at least a portion thereof, can be contained in the cryogenic environment 217, such as for reading a state, frequency and/or other characteristic of qubit, excited, decaying or otherwise.

It is noted that the aforementioned description(s) refer(s) to the operation of a single set of instructions run on a single qubit. However, scaling can be achieved. For example, instructions can be calculated, transmitted, employed and/or otherwise used relative to one or more qubits (e.g., non-neighbor qubits) in parallel with one another, one or more quantum circuits in parallel with one another, and/or one or more qubit mappings in parallel with one another.

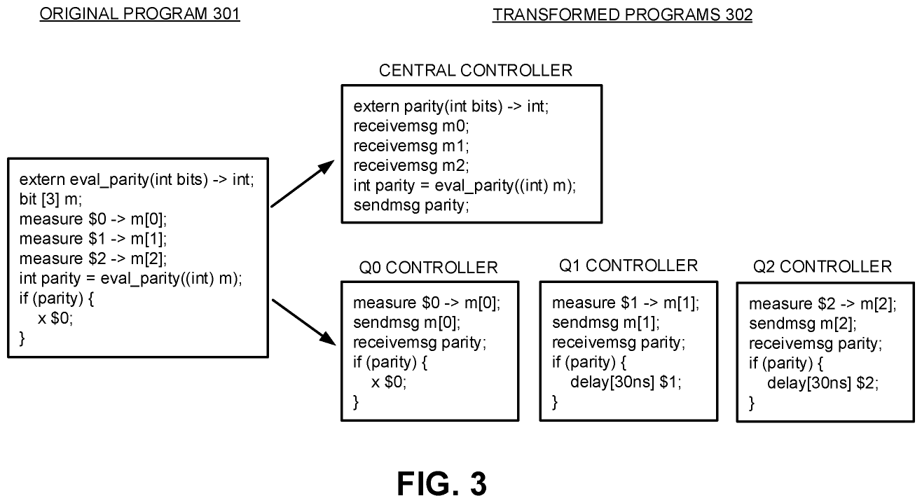

Referring now to FIG. 3, and with further reference to FIG. 1, an example quantum program 301 that includes operations performed to three qubits is illustrated. In embodiments, the quantum program 301 shown in FIG. 3 can be provided as quantum application data 120 to the quantum control system 102 of FIG. 1. FIG. 3 shows that for an original quantum program 301 that is programmed at the circuit level, e.g., where gates are applied to qubits, corresponding measurement results are obtained, and then a computation is evaluated and used as a basis for a subsequent action, the original quantum program 301 can be written as a single program, e.g., via a client application or other means. However, once the original quantum program 301 is executed in a quantum system 201, the original quantum program 301 can be transformed into a series of transformed programs 302 where different components, here qubit controllers 402 for qubits Q0, Q1, and Q2 and a central controller entity (e.g., the quantum control system 102 and/or components thereof), are performing different actions associated with the original program 301.

With regard to the transformed programs 302, FIG. 3 shows that the central controller can be responsible for accumulating measurement results and then computing the next decision to make, e.g., for the next block to execute. Additionally, FIG. 3 shows that the qubit controllers 402 can, in turn, send and/or receive stimuli to and/or from their associated qubits and then receive the next decision (e.g., regarding the next block to execute). The qubit controllers 402 can then be responsible for executing those selected blocks at the signal and/or stimulus level.

Turning next to FIG. 4, illustrated is a block diagram of an example, non-limiting system 400 that can facilitate a quantum control system architecture with low-latency unstructured control flow in accordance with one or more embodiments described herein. The non-limiting system 400 can comprise a quantum system 201, e.g., which can operate, either wholly or in part, as described above with respect to FIG. 2. The quantum system 201, in turn, can include one or more qubit controllers 402 that can interface with respectively associated qubits 207. While only one qubit controller 402 and qubit 207 are shown in FIG. 4, it is noted that the quantum system 201 can include any suitable number of qubit controllers 402 and/or qubits 207. Further, while FIG. 4 illustrates a one-to-one mapping between a qubit controller 402 and a qubit 207, it is noted that there could instead be a many-to-one, one-to-many, and/or many-to-many mapping between qubit controllers 402 and qubits 207 as appropriate.

It is additionally noted that the qubit controller 402 is only briefly detailed to provide a lead-in to a more complex and/or more expansive qubit controller 402 as illustrated at FIG. 5. That is, further detail regarding processes that can be performed by one or more embodiments described herein will be provided below relative to the non-limiting system 500 of FIG. 5.

Still referring to FIG. 4, the qubit controller 402 can comprise at least a memory 404, bus 405, processor 406, staging component 410, and control component 412. Using these components, the qubit controller 402 can perform operations based on real-time control sequences indicated in a control message 130 provided by a quantum control system 102 (e.g., as described above with respect to FIG. 1), such as sending waveform stimuli or other stimuli to an associated qubit 207 and performing corresponding measurements. The qubit controller 402 can then, e.g., via the quantum system 201, provide measurement outcome data 140 associated with those measurements back to the quantum control system 102, e.g., to enable further decision making at the quantum control system 102.

In an embodiment as shown by FIG. 4, the staging component 410 of the qubit controller 402 can locate a real-time qubit control sequence within a block table associated with the qubit controller 402 based on addressing information provided in a message, e.g., the control message 130, received from a remote controller device, such as a device associated with the quantum control system 102, at a first time. Examples of memory structures that can be utilized for storing control sequences at the qubit controller 402, e.g., via a block table, are described in further detail below with respect to FIG. 8.

The control component 412 of the qubit controller 402 can then execute the real-time control sequence located by the staging component 410 on quantum hardware, e.g., an associated qubit 207, at a second time that is given by the control message 130. In embodiments, the second time at which the control component 412 executes the real-time control sequence can be after the first time at which the staging component 410 receives the control message 130, thereby enabling the qubit controller 402 to perform operations at a precisely controlled future action time to facilitate synchronization between qubit controllers 402 and the quantum control system 102. To further facilitate this synchronization, the first time and the second time utilized by the qubit controller 402 can be based on a common clock signal that is common to both the quantum control system 102 and the qubit controller 402. An example of a system architecture that facilitates such a clock signal is described in further detail below with respect to FIG. 6.

In general, the non-limiting system 400 can employ any suitable method of communication (e.g., electronic, communicative, internet, infrared, fiber, etc.) to provide communication between the quantum control system 102 and the quantum system 201 and/or respective components thereof, such as qubit controllers 402 or the like.

Turning next to FIG. 5, a non-limiting system 500 is illustrated that can comprise a quantum system 201 comprising a qubit controller 402. Repetitive description of like elements and/or processes employed in respective embodiments is omitted for brevity. Description relative to an embodiment of FIG. 4 can be applicable to an embodiment of FIG. 5. Likewise, description relative to an embodiment of FIG. 5 can be applicable to an embodiment of FIG. 4.

Generally, the qubit controller 402 of the quantum system 201 can communicate with (e.g., send waveform stimuli and/or other stimuli to, take measurements from, etc.) an associated qubit 207 based on instructions indicated by a control message 130 from a quantum control system 102 at times designated by the quantum control system 102, in order to enable gapless and synchronized control flow between qubit controllers 402 of the quantum system 201. This can, in turn, reduce accumulated error in the quantum system 201 (e.g., by enabling techniques such as dynamical decoupling) compared to a quantum system that does not utilize the control flow shown in FIG. 5.

One or more communications between one or more components of the non-limiting system 500 can be provided by wired and/or wireless means, such as the communication schemes described above with respect to the non-limiting system 100 in FIG. 1.

The qubit controller 402 can comprise a plurality of components. The components can comprise a memory 404, processor 406, bus 405, staging component 410, control component 412, and reporting component 510. Using these components, the qubit controller 402 can locate a real-time qubit control sequence within a block based on addressing information provided in a control message 130 and execute the real-time qubit control sequence on an associated qubit at an action time given by the control message 130.

Discussion next turns briefly to the processor 406, memory 404 and bus 405 of the qubit controller 402. In one or more embodiments, a component associated with the qubit controller 402, as described herein with or without reference to the one or more figures of the one or more embodiments, can comprise one or more computer and/or machine readable, writable and/or executable components and/or instructions that can be executed by processor 406 to provide performance of one or more processes defined by such component and/or instruction. In one or more embodiments, the processor 406 can comprise the staging component 410, control component 412, and reporting component 510. In some embodiments, the processor 406 can be a special-purpose processor that can include instruction memory, special-purpose extensions, and/or other attributes that facilitate building sequences for sending and receiving waveforms to and/or from a qubit 207. An example structure that can be utilized by the processor 406 is described below with respect to FIG. 7.

In one or more embodiments, the qubit controller 402 can comprise the computer-readable memory 404 that can be operably connected to the processor 406. The memory 404 can store computer-executable instructions that, upon execution by the processor 406, can cause the processor 406 and/or one or more other components of the qubit controller 402 (e.g., staging component 410, control component 412, and reporting component 510) to perform one or more actions. In one or more embodiments, the memory 404 can store computer-executable components (e.g., staging component 410, control component 412, and reporting component 510).

The qubit controller 402 and/or its respective components as described above can additionally be coupled to each other via bus 405, which can function in a similar manner to bus 105 described above with respect to FIG. 1.

Turning now to discussion of the components of the qubit controller 402 shown in FIG. 5, as described above, the staging component 410 and control component 412 can facilitate execution of a real-time control sequence at a time specified by a control message 130 received from a quantum control system 102. Additionally, the reporting component 510 can transmit measurement outcome data 140 and/or information relating to a property of a qubit 207, e.g., resulting from application of a stimulus applied to the qubit 207 in connection with a control sequence, back to the quantum control system 102.

With reference now to FIG. 6, and with further reference to FIGS. 1 and 5, a non-limiting example system 600 facilitating communication between a host system 610, a quantum control system 102, and qubit controllers, here N qubit controllers 402A-402N, is illustrated. It is noted that the numbering convention used for the qubit controllers 402A-402N and their associated qubits 207A-207N is not intended to imply any specific number of qubit controllers and/or qubits.

The non-limiting example system 600 shown in FIG. 6 includes a host system 610, which can include one or more computing devices, e.g., general-purpose computing devices, that can provide respective classical computing functionality for the non-limiting system 600. This functionality can include, but is not limited to, providing an interface between the non-limiting system 600 and client computing devices (e.g., to enable client applications or programs to be executed on the non-limiting system), facilitating general operation and/or management of the non-limiting system 600, and/or other functionality.

As further shown in FIG. 6, the host system 610 is communicatively coupled to a quantum control system 102, which can be responsible for making decisions in connection with a given quantum application or program. The quantum control system 102 maintains communication links to the respective qubit controllers 402A-402N to facilitate communication between the quantum control system and the qubit controllers 402A-402N. In implementations, the quantum control system 102 and qubit controllers 402A-402N can be communicatively coupled via a low-latency messaging network, e.g., comprising midplane connections between the quantum control system 102 and qubit controllers 402A-402N. This messaging network can be utilized by various components of the quantum control system 102 and the qubit controllers 402A-402N, such as the synchronization component 112 of the quantum control system 102 (FIG. 1) and the staging component 410 and/or reporting component 510 of the qubit controllers 402A-402N (FIG. 5), to facilitate low-latency unstructured control flow within the non-limiting system 600. In embodiments, the messaging network between the quantum control system 102 and the qubit controllers 402A-402N can enable the quantum control system 102 to send, with low latency, decisions to the qubit controllers 402A-402N regarding blocks to execute and specific times at which to execute those blocks.

The qubit controllers 402A-402N can, in turn, be connected, e.g., via wired connections, to respectively associated qubits 207A-207N, which can be located in a cryogenic environment and/or other environment suitable for proper operation of the qubits 207A-207N. While not shown in FIG. 6, the qubit controllers 402A-402N could also include additional network interfaces, such as an Ethernet interface or the like, to enable direct communication between the qubit controllers 402A-402N and the host system 610.

As further shown in FIG. 6, the quantum control system 102 can be communicatively coupled to a clock source 620, which can include one or more software and/or hardware elements that facilitate providing a shared or common clock signal to respective devices in the non-limiting system 600. For instance, as shown, the quantum control system 102 can access the common clock signal directly via its direct coupling to the quantum control system 102, and the respective qubit controllers 402A-402N can access the common clock signal using, e.g., the messaging network described above that couples the quantum control system 102 to the qubit controllers 402A-402N. By enabling the use of a common clock signal via the clock source 620, each of the devices in the non-limiting system 600 can reference the same notion of time, which can facilitate improved synchronization of the devices in the non-limiting system 600.

Other implementations of the clock source 620 are also possible. For instance, the clock source 620 could be implemented as part of the host system 610, and respective devices of the non-limiting system 600 can access an associated shared clock signal via the host system 610. In other implementations, the clock source 620 could communicate directly with multiple different types of devices in the non-limiting system 600, such as the quantum control system 102 and the qubit controllers 402N. In still other implementations, the clock source 620 could be integrated into the quantum control system 102 and/or one or more of the qubit controllers 402A-402N. Other implementations are also possible.

The non-limiting system 600 shown in FIG. 6 can be utilized to alter the execution model of a quantum program in a manner that provides enhanced synchronization between the elements of the non-limiting system 600. For instance, instead of the quantum control system 102 communicating a decision value to the qubit controllers 402A-402N and then causing the qubit controllers 402A-402N to do their own individual branching decisions, the quantum control system 102 of non-limiting system 600 can explicitly communicate (e.g., via a control message 130 sent by the synchronization component 112) the next block to execute, and specific times at which to execute the instructions in that block, to the qubit controllers 402A-402N. This can have the effect of moving branching decisions from the individual qubit controllers 402A-402N to the quantum control system 102, thereby removing a potential source of desynchronization between the qubit controllers 402A-402N.

While FIG. 6 illustrates a system 600 that includes one quantum control system 102, it is noted that implementations of system 600 could also include multiple quantum control systems 102, which could be arranged, for example, hierarchically and/or as peer systems. Also or alternatively, multiple quantum control systems 102 within system 600 could be arranged according to any suitable network topology or topologies, such as a tree-like, star-like, or hypercube-like topology, and/or other topologies. In an implementation that utilizes multiple quantum control systems 102, the quantum control systems 102 could be communicatively coupled to each other, and/or to the host system 610 and/or qubit controllers 402A-402N, via any suitable communication technologies.

Referring back to FIG. 1, and with further reference to FIG. 6, the synchronization component 112 of the quantum control system 102 can operate based on a Send Synchronization Message (SENDSYNQ) instruction to structure and send a control message 130 to the qubit controllers 402A-402N. A control message 130 sent by the quantum control system 102 based on a SENDSYNQ instruction can include information regarding a block of instructions to be executed by a given qubit controller 402 as well as a future action time (FAT) at which to execute that block of instructions. Further details regarding the manner in which this control message 130 is received and interpreted by the qubit controllers 402A-402N are provided below with respect to FIGS. 7-8. Information provided within the control message 130 by the synchronization component 112 can be computed, e.g., by the orchestration component 110, dynamically based on an application running on the quantum control system 102.

With additional reference now to FIG. 7, a state diagram of an example, non-limiting quantum program flow 700 that can be utilized for collective execution of a quantum program by the quantum control system 102 and qubit controllers 402A-402N of FIG. 6 is illustrated. The program flow 700 begins from a halted state 702 via an external triggering event. In response to the triggering event, the program flow 700 enters a prelude state 704, in which the quantum control system 102 and the qubit controllers 402A-402N execute prelude code in preparation for executing the quantum program.

The program flow 700 next enters an initializing state 706, in which the quantum control system 102 and qubit controllers 402A-402N prepare for execution of an initial code block associated with the quantum program. For instance, the quantum control system 102 can prepare and send an initial control message 130 to the qubit controllers 402A-402N, e.g., via a SENDSYNQ instruction at the quantum control system 102, in the initializing state. A control message 130 sent during the initializing state 706 can be broadcast to all qubit controllers 402A-402N, or alternatively tailored control messages 130 can be sent to respective qubit controllers 402A-402N individually.

Following the initializing state 706, the qubit controllers 402A-402N can enter a waiting phase characterized by a Wait and Branch at Future Action Time (WAITBRAT) instruction, referred to in FIG. 7 as a WAITBRAT phase 710. The WAITBRAT phase 710 begins with an awaiting message state 712, in which the qubit controllers 402A-402N wait for a control message 130 to be received from the quantum control system 102.

As noted, the awaiting message state 712 can be triggered at the qubit controllers 402A-402N based on a WAITBRAT instruction issued to the qubit controllers 402A-402N. The WAITBRAT instruction can cause a qubit controller 402, e.g., via a staging component 410, to wait for a control message 130 to arrive from the quantum control system 102. The control message 130 can be constructed according to a specialized format in which encoded into the message are both an indicator of a block to select as well as the time at which to invoke that block.

With additional reference now to FIG. 8, a non-limiting example architecture that can be employed by a qubit controller 402 is illustrated in connection with the operations performed in connection with the program flow 700. As shown in FIG. 8, the qubit controller 402 can receive and decode a control message 130 from a quantum control system 102 via a communications block 802, e.g., based on a WAITBRAT message and during the awaiting message state 712.

The control message 130 can, e.g., based on a SENDSYNQ instruction executed by the quantum control system 102, encode the block to execute as an index within a block jump table 806 maintained by the qubit controller 402. In implementations, the block jump table 806 can be a hardware memory that is used to map block indexes to locations of code blocks 811 stored in an instruction memory 810. Upon receiving a control message 130, the staging component 410 of the qubit controller 402 (e.g., as implemented via a central processing unit (CPU) 804) can look up the location of the block to be executed in the instruction memory 810 based on the block jump table 806.

With reference again to FIG. 7, after receiving a control message 130 during the awaiting message state 712, a qubit controller 402 can inter an awaiting FAT state 714, in which the qubit controller 402 waits against its shared clock (e.g., as provided via the clock source 620) for the FAT encoded into the control message 130. When the FAT equals the current time, e.g., as maintained by the CPU 804, the qubit controller 402 can transition from the awaiting FAT state 714 to a branching state 716, in which the qubit controller 402, e.g., via the CPU 804, branches to the address pointed to in the block jump table 806 as given by the control message 130.

Upon successfully branching during the branching state 716, the program flow 700 enters a block phase 720 in which the qubit controller 402, e.g., via a control component 412, can execute the corresponding block indicated in the control message 130. The block phase 720 shown in FIG. 7 can begin with a block setup state 722, in which the control component 412 (e.g., as implemented via the CPU 804) can prepare respective waveform stimuli to be applied to an associated qubit 207 based on waveforms stored in a waveform memory 812 and/or a waveform table 814. The block phase 720 then enters a sequence generation state 724, in which the control component 412 of the qubit controller 402 applies the appropriate stimuli to the qubit 207 via a waveform engine 816 and performs appropriate measurements based on those stimuli. Subsequently, measurement outcome data 140 associated with those measurements can be reported back to the quantum control system 102 (e.g., via a reporting component 510) to facilitate subsequent control flow at the quantum control system 102.

In the program flow 700 shown by FIG. 7, each block of execution can be terminated with an additional WAITBRAT instruction. Accordingly, upon completion of a block, a qubit controller 402 can return to the awaiting message state 712 of the WAITBRAT phase 710 to await further instructions. In the event that further blocks are to be executed, the qubit controller 402 can facilitate branching and execution for the further blocks, e.g., during the WAITBRAT phase 710 and the block phase 720 as described above. Upon reaching the end of a given program, the quantum control system 102 can send the qubit controller 402 a halt instruction during the awaiting message state 712. As a result of receiving the halt instruction, the qubit controller 402 can branch at the branching state 716 back to the halted state 702.

With further reference to FIG. 8, the blocks 811 within the instruction memory 810 for a given program can be written at the time the program is compiled, e.g., such that the blocks 811 can subsequently be loaded at runtime. The specific instructions written to the blocks 811 for a given qubit controller 402 can vary based on the program being run, and additionally instructions can be written on a per-controller basis. For instance, a first set of instructions can be written to the instruction memory 810 of a first qubit controller 402, and a second, different set of instructions can be written to the instruction memory 810 of a second qubit controller 402. In this way, different programs can be stored for each qubit controller 402 such that the respective qubit controllers 402 execute different code in a synchronized manner as set forth above.

In embodiments, a compiler associated with a given quantum program can ensure that the code sequences written to respective qubit controllers 402 are the same length, e.g., in order to maintain synchronization between the qubit controllers 402. However, because the code sequences can be different between different qubit controllers 402, the quantum control system 102 can trigger unique sequences for each individual qubit controller 402 that can be synchronized in execution by communicating only the block sequence to execute at runtime, e.g., rather than the complete sequence.

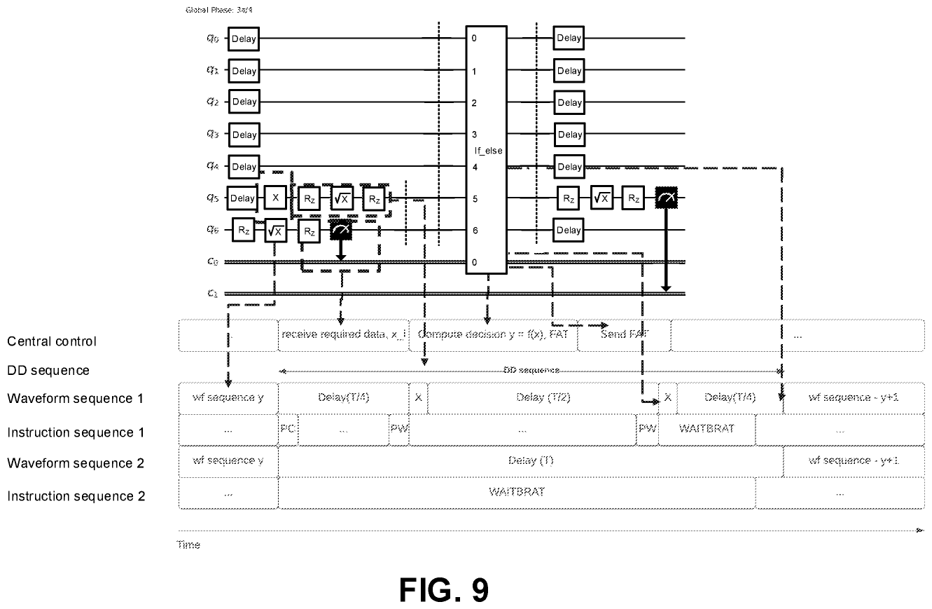

Turning now to FIG. 9, example instruction execution timing that can be facilitated by the non-limiting systems of FIGS. 1, 4, and/or 5 in accordance with one or more embodiments described herein is illustrated. In particular, FIG. 9 shows an example dynamical decoupling (DD) sequence that can be facilitated by a quantum computing system comprising a central control element (e.g., a quantum control system 102), including waveform and instruction sequences that can be performed by respective qubit controllers (e.g., qubit controllers 402).

In the example shown by FIG. 9, the central control element can facilitate gapless operation of associated qubit controllers, e.g., by scheduling execution of a previous block to end as execution of a subsequent block begins. To facilitate this, the central control element can determine the duration of each block and then select a first block, e.g., Block 0, to execute. Based on selecting Block 0 for execution as well as the amount of execution time associated with Block 0, the central control block can trigger execution of Block 0 via a SENDSYNQ instruction, e.g., as described above.

The qubit controllers, in turn, can begin executing Block 0, and in the process the qubit controllers can produce data that can be used to compute the next decision of the block to execute. The central control block can receive that data, and once the central control block has the data associated with computing the next decision, e.g., as encoded in its program, it can compute the block to execute next, e.g., Block 1, by branching. The central control block can then determine when Block 1 can be executed, and because central control block can previously determine the duration of the previous block, it can determine whether the previous block has already been executed.

In the event that the previous block has already been executed, the central control block can select the earliest possible time to execute the next block. However, because doing so can result in a gap in the waveform output, the SENDSYNQ instruction at the central control block can cause the central control block to communicate a start time for the next block, e.g., Block 1, that is equal to the time Block 0 started executing plus the duration of Block 0. As a result, the waveforms of Block 1 can start to emit just as the waveforms of Block 0 are completed in the hardware, which can enable techniques such as dynamical decoupling and general waveform emission without any gaps in the signal.

In embodiments, the central control block can determine which block to execute next while the previous block is executing, e.g., based on information produced by the previous block in the event that measurements are taking place. If the measurement information does not get produced until the end of the previous block, it can take an amount of time to communicate that information back to the central control block, make a corresponding decision, and communicate that decision back to the qubit controllers. In such a case, the central control block can select, as the execution time for the next block, the maximum of the ending time of the previous sequence at the qubit controllers plus a communication or overhead time associated with making a decision regarding the next block. By doing so, the system can minimize the amount of idle time in the system in cases in which some amount of idle time is unavoidable.

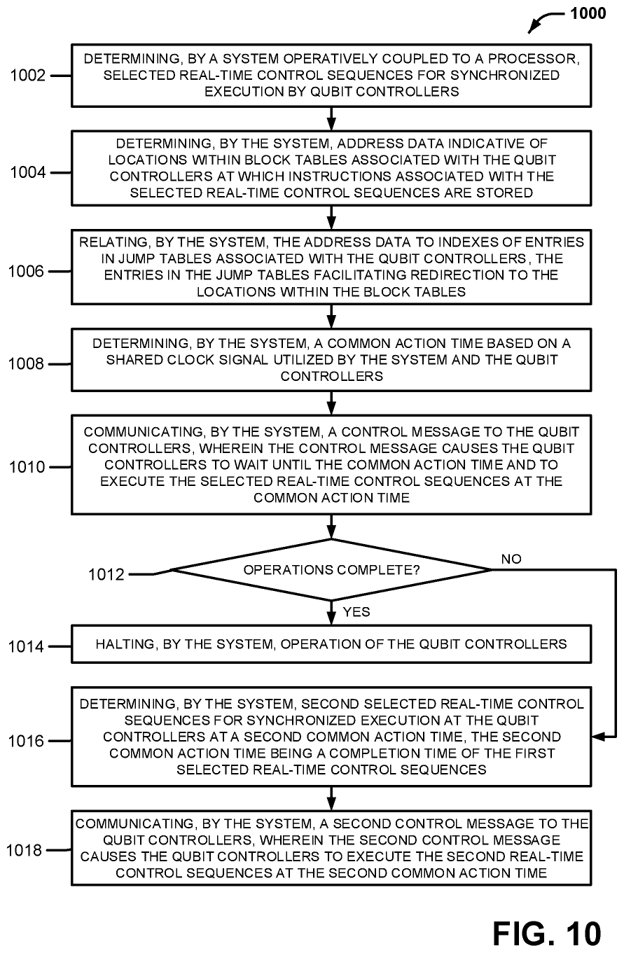

As another summary, referring next to FIG. 10, illustrated is a flow diagram of an example, non-limiting method 1000 that can provide a quantum control system architecture with low-latency unstructured control flow in accordance with one or more embodiments described herein, such as the non-limiting system 100 of FIG. 1. While the non-limiting method 1000 is described relative to the non-limiting system 100 of FIG. 1, the non-limiting method 1000 can be applicable also to other systems described herein. Repetitive description of like elements and/or processes employed in respective embodiments is omitted for sake of brevity.

At 1002, the non-limiting method 1000 can comprise determining, by a system operatively coupled to a processor (e.g., orchestration component 110), real-time control sequences for synchronized execution by qubit controllers (e.g., qubit controllers 402 of a quantum system 201).

At 1004, the non-limiting method 1000 can comprise determining, by the system (e.g., orchestration component 110), address data indicative of locations within block tables (e.g., blocks 811 of an instruction memory 810) associated with the qubit controllers at which instructions associated with the selected real-time control sequences are stored.

At 1006, the non-limiting method 1000 can comprise relating, by the system (e.g., orchestration component 110), the address data to indexes of entries in jump tables (e.g., block jump tables 806) associated with the qubit controllers, the entries in the jump tables facilitating redirection to the locations within the block tables.

At 1008, the non-limiting method 1000 can comprise determining, by the system (e.g., orchestration component 110), a common action time (e.g., a FAT) based on a shared clock signal (e.g., from a clock source 620) utilized by the system and the qubit controllers.

At 1010, the non-limiting method 1000 can comprise communicating, by the system (e.g., synchronization component 112), a control message (e.g., control message 130) to the qubit controllers, wherein the control message causes the qubit controllers to wait until the common action time and to execute the selected real-time control sequences at the common action time.

At 1012, the non-limiting method 1000 can comprise determining, by the system (e.g., orchestration component 110), if all operations to be performed (e.g., associated with a quantum program) are complete.

If yes, the non-limiting method 1000 can conclude at 1014, which can comprise halting, by the system (e.g., synchronization component 112) operation of the qubit controllers. If no, the non-limiting method 1000 can proceed forward to 1016.

At 1016, the non-limiting method 1000 can comprise determining, by the system (e.g., orchestration component 110), second selected real-time control sequences for synchronized execution at the qubit controllers at a second common action time, the second common action time being a completion time of the first selected real-time control sequences.

At 1018, the non-limiting method 1000 can comprise communicating, by the system (synchronization component 112), a second control message to the qubit controllers, wherein the second control message causes the qubit controllers to execute the second real-time control sequences at the second common action time.

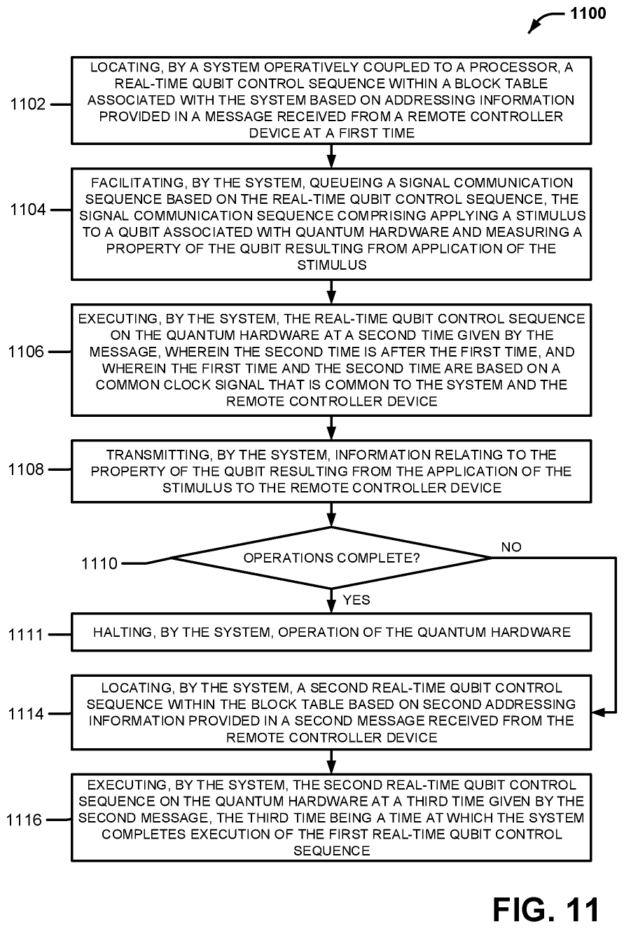

As an additional summary, referring next to FIG. 11, illustrated is a flow diagram of another example, non-limiting method 1100 that can provide a quantum control system architecture with low-latency unstructured control flow in accordance with one or more embodiments described herein, such as the non-limiting system 500 of FIG. 5. While the non-limiting method 1000 is described relative to the non-limiting system 500 of FIG. 5, the non-limiting method 1000 can be applicable also to other systems described herein, such as the non-limiting system 400 of FIG. 4. Repetitive description of like elements and/or processes employed in respective embodiments is omitted for sake of brevity.

At 1102, the non-limiting method 1100 can comprise locating, by a system operatively coupled to a processor (e.g., staging component 410), a real-time qubit control sequence within a block table (e.g., blocks 811 of an instruction memory 810) associated with the system based on addressing information provided in a message (e.g., control message 130) received from a remote controller device (e.g., quantum control system 102) at a first time.

At 1104, the non-limiting method 1100 can comprise facilitating, by the system (e.g., staging component 410), queueing a signal communication sequence based on the real-time qubit control sequence, the signal communication sequence comprising applying a stimulus to a qubit (e.g., qubit 207) associated with quantum hardware (e.g., quantum system 201) and measuring a property of the qubit resulting from application of the stimulus.

At 1106, the non-limiting method 1100 can comprise executing, by the system (e.g., control component 412), the real-time qubit control sequence on the quantum hardware at a second time (e.g., a FAT) given by the message, wherein the second time is after the first time, and wherein the first time and the second time are based on a common clock signal (e.g., given by a clock source 620) that is common to the system and the remote controller device.

At 1108, the non-limiting method 1100 can comprise transmitting, by the system (e.g., reporting component 510), information relating to the property of the qubit resulting from the application of the stimulus to the remote controller device.

At 1110, the non-limiting method 1100 can comprise determining, by the system (e.g., staging component 410), if all operations to be performed (e.g., associated with a quantum program) are complete.

If yes, the non-limiting method 1100 can conclude at 1112, which can comprise halting, by the system (e.g., control component 412) operation of the quantum hardware. If no, the non-limiting method 1100 can proceed forward to 1114.

At 1114, the non-limiting method 1100 can comprise locating, by the system (e.g., staging component 410), a second real-time qubit control sequence within the block table based on second addressing information provided in a second message received from the remote controller device.

At 1116, the non-limiting method 1100 can comprise executing, by the system (control component 412), the second real-time qubit control sequence on the quantum hardware at a third time given by the second message, the third time being a time at which the system completes execution of the first real-time qubit control sequence.

### Additional Summary

For simplicity of explanation, the computer-implemented and non-computer-implemented methodologies provided herein are depicted and/or described as a series of acts. It is to be understood that the subject innovation is not limited by the acts illustrated and/or by the order of acts, for example acts can occur in one or more orders and/or concurrently, and with other acts not presented and described herein. Furthermore, not all illustrated acts can be utilized to implement the computer-implemented and non-computer-implemented methodologies in accordance with the described subject matter. In addition, the computer-implemented and non-computer-implemented methodologies could alternatively be represented as a series of interrelated states via a state diagram or events. Additionally, the computer-implemented methodologies described hereinafter and throughout this specification are capable of being stored on an article of manufacture for transporting and transferring the computer-implemented methodologies to computers. The term article of manufacture, as used herein, is intended to encompass a computer program accessible from any computer-readable device or storage media.

The systems and/or devices have been (and/or will be further) described herein with respect to interaction between one or more components. Such systems and/or components can include those components or sub-components specified therein, one or more of the specified components and/or sub-components, and/or additional components. Sub-components can be implemented as components communicatively coupled to other components rather than included within parent components. One or more components and/or sub-components can be combined into a single component providing aggregate functionality. The components can interact with one or more other components not specifically described herein for the sake of brevity, but known by those of skill in the art.

In summary, the one or more embodiments described herein can provide systems, computer-implemented methods and/or computer program products to facilitate a quantum control system architecture with low-latency unstructured control-flow, e.g., including gapless waveform playback through remote invocation of control subsequences.

Benefits of the systems, computer-implemented methods and/or computer programs products can include, e.g., the following. Reduction in the amount of time qubits controlled via the qubit controllers are in an idle state, which can in turn reduce an amount of error associated with the qubits. Reducing messaging latency associated with quantum circuit execution, e.g., by enabling qubit controllers to refer to pre-written control sequences during execution, and/or by facilitating communication of a comparatively short reference to a group of instructions within a jump table rather than the instructions themselves. Improved control over the operation of an underlying qubit on a per-operation basis. Further reduction of system error, e.g., by removing or significantly reducing the amount of time a qubit is idle between control sequences. Enabling synchronization between the system and the qubit controllers without maintaining separate clock sources at each device. Other benefits are also possible.

Further benefits of the systems, computer-implemented methods and/or computer programs products can include, e.g., the following. Reducing qubit error proportional to the amount of time a qubit controlled by a qubit controller is in an idle state, e.g., by enabling a qubit controller to act in synchronization with other qubit controllers at the same time. Enabling synchronization between a qubit controller and a quantum control system without maintaining separate clock sources at each device. Reducing messaging latency associated with quantum circuit execution, e.g., by facilitating communication of a comparatively short reference to a group of instructions within a jump table rather than the instructions themselves. Improved control over the operation of a qubit on a per-operation basis. Enabling a quantum control system to make decisions regarding subsequent control or computation sequences in real time, which can enable the quantum control system to schedule control sequences for execution by a qubit controller in a gapless manner and improve the ability to provide feedforward or feedback (e.g., quantum control flow) during operation of quantum circuits on quantum hardware due to the decreased latency in messaging. Reducing system errors, e.g., by removing or significantly reducing the amount of time a qubit is idle between control sequences. Other benefits are also possible.

Yet another benefit of the systems, computer-implemented methods and/or computer program products can generally be an improvement in the functioning of a quantum computer. This improvement over existing computerized technologies and/or quantum computerized technologies improves the function of a quantum computer with respect to reduced coherent error accumulation at qubits associated with the quantum computer. More particularly, the benefit can comprise an ability to improve the efficiency of using a quantum computer, and the accuracy of computations performed by a quantum computer, by reducing the amount of time during which error can accumulate within the quantum computer. Moreover, the systems, computer-implemented methods and/or computer program products provided herein can provide additional improvements to the performance of quantum applications by enabling the implementation of techniques such as quantum error correction in connection with the quantum applications.

That is, through use of the systems, computer-implemented methods and/or computer program products, operations performed on respective qubits of a quantum computer can be tightly and efficiently synchronized, reducing qubit downtime during which qubits can decohere. Such amended operation can comprise, but is not limited to, use of a central control system to determine and perform all branching decisions based on real-time measurement information and a shared clock signal used by all elements of the quantum computer.

As a result, the speed of use, efficiency of use, and/or accuracy and/or precision of outputs produced by one or more qubits of the quantum computer can be increased, e.g., via the improved system synchronization resulting from use of the systems, computer-implemented methods and/or computer program products. As a secondary result, the measurement readouts obtained from the quantum computer, based directly on stimuli applied to qubits according to the real-time control sequences described herein, can in turn be improved to be more accurate and/or precise, in turn leading to additional improvements in speed, efficiency, accuracy and/or precision.

Indeed, in view of the one or more embodiments described herein, a practical application of the one or more systems, computer-implemented methods and/or computer program products described herein can be an enhancement in the ability to accurately write and execute quantum computer programs through the use of synchronization processes and/or other processes as provided herein. These processes can be useful in fields of finance, biology, chemistry, materials science, pharmacology and/or drug-delivery using a quantum processor, without being limited thereto. Overall, the one or more systems, computer-implemented methods and/or computer program products described herein can constitute a concrete and tangible technical improvement in the fields of quantum processing and/or quantum dynamics, without being limited thereto.

Furthermore, one or more embodiments described herein can be employed in a real-world system based on the disclosed teachings. For example, one or more embodiments described herein can function in combination with a physical quantum computer having a physical quantum processor. In response to one or more waveforms generated by a waveform generator of the quantum computer, physical quantum qubit hardware of the quantum processor can produce signals and/or changes in state of the qubit hardware, resulting in ability to measure such signals and/or changes in state of the qubit hardware. The measurements, e.g., the measurement outcomes, can be thereafter employed for various inference actions relative to sample quantum data corresponding to one or more quantum circuits having been executed on the quantum computer by way of operation of the waveform generator.

The systems and/or devices have been (and/or will be further) described herein with respect to interaction between one or more components. Such systems and/or components can include those components or sub-components specified therein, one or more of the specified components and/or sub-components, and/or additional components. Sub-components can be implemented as components communicatively coupled to other components rather than included within parent components. One or more components and/or sub-components can be combined into a single component providing aggregate functionality. The components can interact with one or more other components not specifically described herein for the sake of brevity, but known by those of skill in the art.

One or more embodiments described herein can be, in one or more embodiments, inherently and/or inextricably tied to computer technology and cannot be implemented outside of a computing environment. For example, one or more processes performed by one or more embodiments described herein can more efficiently, and even more feasibly, provide program and/or program instruction execution, such as relative to execution of non-Clifford quantum gates, as compared to existing systems and/or techniques. Systems, computer-implemented methods and/or computer program products providing performance of these processes are of great utility in the fields of quantum circuit operation and/or quantum computing more generally and cannot be equally practicably implemented in a sensible way outside of a computing environment.

One or more embodiments described herein can employ hardware and/or software to solve problems that are highly technical, that are not abstract, and that cannot be performed as a set of mental acts by a human. For example, a human, or even thousands of humans, cannot efficiently, accurately and/or effectively automatically perform quantum circuit encoding, load a quantum register, perform quantum calculations, generate a waveform and/or measure a state of qubit as the one or more embodiments described herein can provide these processes. Moreover, neither can the human mind nor a human with pen and paper conduct one or more of these processes, as conducted by one or more embodiments described herein.

In one or more embodiments, one or more of the processes described herein can be performed by one or more specialized computers (e.g., a specialized processing unit, a specialized classical computer, a specialized quantum computer, a specialized hybrid classical/quantum system and/or another type of specialized computer) to execute defined tasks related to the one or more technologies describe above. One or more embodiments described herein and/or components thereof can be employed to solve new problems that arise through advancements in technologies mentioned above, employment of quantum computing systems, cloud computing systems, computer architecture and/or another technology.

One or more embodiments described herein can be fully operational towards performing one or more other functions (e.g., fully powered on, fully executed and/or another function) while also performing one or more of the one or more operations described herein.

To provide additional summary, a listing of embodiments and features thereof is next provided.

A system, comprising: a memory that stores computer executable components; and a processor that executes the computer executable components stored in the memory, wherein the computer executable components comprise: an orchestration component that determines selected real-time control sequences for synchronized execution by qubit controllers; and a synchronization component that communicates a control message to the qubit controllers, herein the control message causes the qubit controllers to wait until a common action time and to execute the selected real-time control sequences at the common action time.

The system of the preceding paragraph, wherein the control message comprises address data indicative of locations within block tables associated with the qubit controllers at which instructions associated with the selected real-time control sequences are stored.

The system of any preceding paragraph, wherein the address data comprises indexes of entries in jump tables associated with the qubit controllers, and wherein the entries in the jump tables facilitate redirection to the locations within the block tables.

The system of any preceding paragraph, wherein the selected real-time control sequences comprise first instructions that facilitate applying a stimulus to an associated qubit and second instructions that facilitate measuring a property of the associated qubit resulting from application of the stimulus.

The system of any preceding paragraph, wherein: the selected real-time control sequences are first selected real-time control sequences, the common action time is a first common action time, the control message is a first control message, the orchestration component further determines second selected real-time control sequences for synchronized execution by the qubit controllers at a second common action time, the second common action time being a completion time of the first selected real-time control sequences, and the synchronization component further communicates a second control message to the qubit controllers, wherein the second control message causes the qubit controllers to execute the second selected real-time control sequences at the second common action time.

The system of any preceding paragraph, wherein the common action time is based on a shared clock signal utilized by the system and the qubit controllers.

A computer-implemented method, comprising: determining, by a system operatively coupled to a processor, selected real-time control sequences for synchronized execution by qubit controllers; and communicating, by the system, a control message to the qubit controllers, wherein the control message causes the qubit controllers to wait until a common action time and to execute the selected real-time control sequences at the common action time.

The computer-implemented method of the preceding paragraph, wherein the control message comprises address data indicative of locations within block tables associated with the qubit controllers at which instructions associated with the selected real-time control sequences are stored.

The computer-implemented method of any preceding paragraph, wherein the address data comprises indexes of entries in jump tables associated with the qubit controllers, and wherein the entries in the jump tables facilitate redirection to the locations within the block tables.

The computer-implemented method of any preceding paragraph, wherein the selected real-time control sequences are first selected real-time control sequences, wherein the common action time is a first common action time, wherein the control message is a first control message, and wherein the computer-implemented method further comprises: determining, by the system, second selected real-time control sequences for synchronized execution by the qubit controllers at a second common action time, the second common action time being a completion time of the first selected real-time control sequences, and communicating, by the system, a second control message to the qubit controllers, wherein the second control message causes the qubit controllers to execute the second selected real-time control sequences at the second common action time.

The computer-implemented method of any preceding paragraph, wherein the common action time is based on a shared clock signal utilized by the system and the qubit controllers.

A computer program product facilitating a process to provide low-latency unstructured control flow in a quantum computer, the computer program product comprising a computer readable storage medium having program instructions embodied therewith, the program instructions executable by a processor to cause the processor to: determine, by the processor, selected real-time control sequences for synchronized execution by qubit controllers; and communicate, by the processor, a control message to the qubit controllers, wherein the control message causes the qubit controllers to wait until a common action time and to execute the selected real-time control sequences at the common action time.

The computer program product of the preceding paragraph, wherein the control message comprises address data indicative of locations within block tables associated with the qubit controllers at which instructions associated with the selected real-time control sequences are stored.

The computer program product of any preceding paragraph, wherein the address data comprises indexes of entries in jump tables associated with the qubit controllers, and wherein the entries in the jump tables facilitate redirection to the locations within the block tables.

The computer program product of any preceding paragraph, wherein the selected real-time control sequences are first selected real-time control sequences, wherein the common action time is a first common action time, wherein the control message is a first control message, and wherein the program instructions are further executable by the processor to cause the processor to: determine, by the processor, second selected real-time control sequences for synchronized execution by the qubit controllers at a second common action time, the second common action time being a completion time of the first selected real-time control sequences, and communicate, by the processor, a second control message to the qubit controllers, wherein the second control message causes the qubit controllers to execute the second selected real-time control sequences at the second common action time.

The computer program product of any preceding paragraph, wherein the common action time is based on a shared clock signal utilized by the processor and the qubit controllers.

A system, comprising: a memory that stores computer executable components; and a processor that executes the computer executable components stored in the memory, wherein the computer executable components comprise: a staging component that locates a real-time qubit control sequence within a block table associated with the system based on addressing information provided in a message received from a remote controller device at a first time; and a control component that executes the real-time qubit control sequence on quantum hardware at a second time given by the message, wherein the second time is after the first time, and wherein the first time and the second time are based on a common clock signal that is common to the system and the remote controller device.

The system of the preceding paragraph, wherein the addressing information comprises an index of an entry of a jump table associated with the system, the entry of the jump table indicating a location of the real-time qubit control sequence within the block table.

The system of any preceding paragraph, wherein the real-time qubit control sequence comprises instructions that facilitate queueing a signal communication sequence, the signal communication sequence comprising applying a stimulus to a qubit associated with the quantum hardware and measuring a property of the qubit resulting from application of the stimulus.

The system of any preceding paragraph, wherein the computer executable components further comprise: a reporting component that transmits information relating to the property of the qubit resulting from the application of the stimulus to the remote controller device.

The system of any preceding paragraph, wherein: the real-time qubit control sequence is a first real-time qubit control sequence, the addressing information is first addressing information, the message is a first message, the staging component locates a second real-time qubit control sequence within the block table based on second addressing information provided in a second message received from the remote controller device, and the control component executes the second real-time qubit control sequence on the associated quantum hardware at a third time given by the second message, the third time being a time at which the control component completes execution of the first real-time qubit control sequence.

A computer-implemented method, comprising: locating, by a system operatively coupled to a processor, a real-time qubit control sequence within a block table associated with the system based on addressing information provided in a message received from a remote controller device at a first time; and executing, by the system, the real-time qubit control sequence on quantum hardware at a second time given by the message, wherein the second time is after the first time, and wherein the first time and the second time are based on a common clock signal that is common to the system and the remote controller device.

The computer-implemented method of the preceding paragraph, wherein the real-time qubit control sequence comprises instructions that facilitate queueing a signal communication sequence, the signal communication sequence comprising applying a stimulus to a qubit associated with the quantum hardware and measuring a property of the qubit resulting from application of the stimulus.

The computer-implemented method of any preceding paragraph, further comprising: transmitting, by the system, information relating to the property of the qubit resulting from the application of the stimulus to the remote controller device.

The computer-implemented method of any preceding paragraph, wherein the real-time qubit control sequence is a first real-time qubit control sequence, wherein the addressing information is first addressing information, wherein the message is a first message, and wherein the computer-implemented method further comprises: locating, by the system, a second real-time qubit control sequence within the block table based on second addressing information provided in a second message received from the remote controller device; and executing, by the system, the second real-time qubit control sequence on the associated quantum hardware at a third time given by the second message, the third time being a time at which the system completes execution of the first real-time qubit control sequence.

### Computing Environment Description

Turning next to FIGS. 12, 13A, and 13B, a detailed description is provided of additional context for the one or more embodiments described herein at FIGS. 1-11.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 1200 contains an example of an environment for the execution of at least some of the computer code involved in performing the inventive methods, such as quantum system control code 1280. In addition to block 1280, computing environment 1200 includes, for example, computer 1201, wide area network (WAN) 1202, end user device (EUD) 1203, remote server 1204, public cloud 1205, and private cloud 1206. In this embodiment, computer 1201 includes processor set 1210 (including processing circuitry 1220 and cache 1221), communication fabric 1211, volatile memory 1212, persistent storage 1213 (including operating system 1222 and block 1280, as identified above), peripheral device set 1214 (including user interface (UI) device set 1223, storage 1224, and Internet of Things (IoT) sensor set 1225), and network module 1215. Remote server 1204 includes remote database 1230. Public cloud 1205 includes gateway 1240, cloud orchestration module 1241, host physical machine set 1242, virtual machine set 1243, and container set 1244.

COMPUTER 1201 may take the form of a desktop computer, laptop computer, tablet computer, smart phone, smart watch or other wearable computer, mainframe computer, or any other form of computer or mobile device now known or to be developed in the future that is capable of running a program, accessing a network or querying a database, such as remote database 1230. As is well understood in the art of computer technology, and depending upon the technology, performance of a computer-implemented method may be distributed among multiple computers and/or between multiple locations. On the other hand, in this presentation of computing environment 1200, detailed discussion is focused on a single computer, specifically computer 1201, to keep the presentation as simple as possible. Computer 1201 may be located in a cloud, even though it is not shown in a cloud in FIG. 12. On the other hand, computer 1201 is not required to be in a cloud except to any extent as may be affirmatively indicated.

PROCESSOR SET 1210 includes one, or more, computer processors of any type now known or to be developed in the future. Processing circuitry 1220 may be distributed over multiple packages, for example, multiple, coordinated integrated circuit chips. Processing circuitry 1220 may implement multiple processor threads and/or multiple processor cores. Cache 1221 is memory that is located in the processor chip package(s) and is typically used for data or code that should be available for rapid access by the threads or cores running on processor set 1210. Cache memories are typically organized into multiple levels depending upon relative proximity to the processing circuitry. Alternatively, some, or all, of the cache for the processor set may be located “off chip.” In some computing environments, processor set 1210 may be designed for working with qubits.

Computer readable program instructions are typically loaded onto computer 1201 to cause a series of operational steps to be performed by processor set 1210 of computer 1201 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 1221 and the other storage media discussed below. The program instructions, and associated data, are accessed by processor set 1210 to control and direct performance of the inventive methods. In computing environment 1200, at least some of the instructions for performing the inventive methods may be stored in block 1280 in persistent storage 1213.

COMMUNICATION FABRIC 1211 is the signal conduction path that allows the various components of computer 1201 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 1212 is any type of volatile memory now known or to be developed in the future. Examples include dynamic type random access memory (RAM) or static type RAM. Typically, volatile memory 1212 is characterized by random access, but this is not required unless affirmatively indicated. In computer 1201, the volatile memory 1212 is located in a single package and is internal to computer 1201, but, alternatively or additionally, the volatile memory may be distributed over multiple packages and/or located externally with respect to computer 1201.

PERSISTENT STORAGE 1213 is any form of non-volatile storage for computers that is now known or to be developed in the future. The non-volatility of this storage means that the stored data is maintained regardless of whether power is being supplied to computer 1201 and/or directly to persistent storage 1213. Persistent storage 1213 may be a read only memory (ROM), but typically at least a portion of the persistent storage allows writing of data, deletion of data and re-writing of data. Some familiar forms of persistent storage include magnetic disks and solid state storage devices. Operating system 1222 may take several forms, such as various known proprietary operating systems or open source Portable Operating System Interface-type operating systems that employ a kernel. The code included in block 1280 typically includes at least some of the computer code involved in performing the inventive methods.

PERIPHERAL DEVICE SET 1214 includes the set of peripheral devices of computer 1201. Data communication connections between the peripheral devices and the other components of computer 1201 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 1223 may include components such as a display screen, speaker, microphone, wearable devices (such as goggles and smart watches), keyboard, mouse, printer, touchpad, game controllers, and haptic devices. Storage 1224 is external storage, such as an external hard drive, or insertable storage, such as an SD card. Storage 1224 may be persistent and/or volatile. In embodiments where computer 1201 is required to have a large amount of storage (for example, where computer 1201 locally stores and manages a large database) then this storage may be provided by peripheral storage devices designed for storing very large amounts of data, such as a storage area network (SAN) that is shared by multiple, geographically distributed computers. IoT sensor set 1225 is made up of sensors that can be used in Internet of Things applications. For example, one sensor may be a thermometer and another sensor may be a motion detector.

NETWORK MODULE 1215 is the collection of computer software, hardware, and firmware that allows computer 1201 to communicate with other computers through WAN 1202. Network module 1215 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 1215 are performed on the same physical hardware device. In other embodiments (for example, embodiments that utilize software-defined networking (SDN)), the control functions and the forwarding functions of network module 1215 are performed on physically separate devices, such that the control functions manage several different network hardware devices. Computer readable program instructions for performing the inventive methods can typically be downloaded to computer 1201 from an external computer or external storage device through a network adapter card or network interface included in network module 1215.

WAN 1202 is any wide area network (for example, the internet) capable of communicating computer data over non-local distances by any technology for communicating computer data, now known or to be developed in the future. In some embodiments, the WAN 1202 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 1203 is any computer system that is used and controlled by an end user (for example, a customer of an enterprise that operates computer 1201), and may take any of the forms discussed above in connection with computer 1201. EUD 1203 typically receives helpful and useful data from the operations of computer 1201. For example, in a hypothetical case where computer 1201 is designed to provide a recommendation to an end user, this recommendation would typically be communicated from network module 1215 of computer 1201 through WAN 1202 to EUD 1203. In this way, EUD 1203 can display, or otherwise present, the recommendation to an end user. In some embodiments, EUD 1203 may be a client device, such as thin client, heavy client, mainframe computer, desktop computer and so on.

REMOTE SERVER 1204 is any computer system that serves at least some data and/or functionality to computer 1201. Remote server 1204 may be controlled and used by the same entity that operates computer 1201. Remote server 1204 represents the machine(s) that collect and store helpful and useful data for use by other computers, such as computer 1201. For example, in a hypothetical case where computer 1201 is designed and programmed to provide a recommendation based on historical data, then this historical data may be provided to computer 1201 from remote database 1230 of remote server 1204.

PUBLIC CLOUD 1205 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 1205 is performed by the computer hardware and/or software of cloud orchestration module 1241. The computing resources provided by public cloud 1205 are typically implemented by virtual computing environments that run on various computers making up the computers of host physical machine set 1242, which is the universe of physical computers in and/or available to public cloud 1205. The virtual computing environments (VCEs) typically take the form of virtual machines from virtual machine set 1243 and/or containers from container set 1244. It is understood that these VCEs may be stored as images and may be transferred among and between the various physical machine hosts, either as images or after instantiation of the VCE. Cloud orchestration module 1241 manages the transfer and storage of images, deploys new instantiations of VCEs and manages active instantiations of VCE deployments. Gateway 1240 is the collection of computer software, hardware, and firmware that allows public cloud 1205 to communicate through WAN 1202.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 1206 is similar to public cloud 1205, except that the computing resources are only available for use by a single enterprise. While private cloud 1206 is depicted as being in communication with WAN 1202, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 1205 and private cloud 1206 are both part of a larger hybrid cloud.

FIG. 13A illustrates a block diagram of an example hybrid computing system 1300 that can facilitate execution of a quantum algorithm. As shown, a client device 1310 may interface with a classical backend 1320 to enable computations with the aid of a quantum system 1330.

Network 1302 may be any combination of connections and protocols that will support communications between the client device 1310, the classical backend 1320, and the quantum system 1330. In an example embodiment, network 1302 may include WAN 1202.

Client device 1310 may be an implementation of computer 1201 or EUD 1203, described in more detail with reference to FIG. 12, configured to operate in a hybrid computing system 1300. In some implementations, the client device 1310 can be utilized to generate quantum application data, e.g., quantum application data 120 as shown in FIG. 1, for use by a quantum control system 102 (e.g., as implemented by the classical backend 1320 as described below) and/or other systems.

Client application 1311 may include an application or program code that includes computations requiring a quantum algorithm or quantum operation. In an embodiment, client application 1311 may include an object-oriented programming language, such as Python® (“Python” is a registered trademark of the Python Software Foundation), capable of using programming libraries or modules containing quantum computing commands or algorithms, such as QISKIT (“QISKIT” is a registered trademark of the International Business Machines Corporation). In another embodiment, client application 1311 may include machine level instructions for performing a quantum circuit, such as OpenQASM. Additionally, user application may be any other high-level interface, such as a graphical user interface, having the underlying object oriented and/or machine level code as described above.

The classical backend 1320 may be an implementation of computer 1201, described in more detail with reference to FIG. 12. In implementations, the classical backend 1320 can be used to provide at least a portion of the functionality of a quantum control system 102, e.g., as described in further detail above with respect to FIGS. 1, 4, 5, and/or 6, and/or other systems. The classical backend 1320 can have program modules configured to operate in a hybrid computing system 1300. Such program modules for classical backend 1320 may include algorithm preparation 1321, classical computation 1323, and data store 1324.

Algorithm preparation 1321 may be a program or module capable of preparing algorithms contained in client application 1311 for operation on quantum system 1330. Algorithm preparation 1321 may be instantiated as part of a larger algorithm, such as a function call of an API, or by parsing a hybrid classical-quantum computation into aspects for quantum and classical calculation. Algorithm preparation 1321 may additionally compile or transpile quantum circuits that were contained in client application 1311 into an assembly language code for use by the local classical controller 1331 to enable the quantum processor 1333 to perform the logical operations of the circuit on physical structures. During transipilation/compilation an executable quantum circuit in the quantum assembly language may be created based on the calculations to be performed, the data to be analyzed, and the available quantum hardware. In one example embodiment, algorithm preparation 1321 may select a quantum circuit from a library of circuits that have been designed for use in a particular problem. In another example embodiment, algorithm preparation 1321 may receive a quantum circuit from the client application 1311 and may perform transformations on the quantum circuit to make the circuit more efficient, or to fit the quantum circuit to available architecture of the quantum processor 1333. Additionally, algorithm preparation 1321 may prepare classical data from data store 1324, or client application 1311, as part of the assembly language code for implementing the quantum circuit by the local classical controller 1331. Algorithm preparation 1321 may additionally set the number of shots (i.e., one complete execution of a quantum circuit) for each circuit to achieve a robust result of the operation of the algorithm. Further, algorithm preparation 1321 may update, or re-compile/re-transiple, the assembly language code based on parallel operations occurring in classical computing resource 1323 or results received during execution of the quantum calculation on quantum system 1330. Additionally, algorithm preparation 1321 may determine the criterion for convergence of the quantum algorithm or hybrid algorithm.

Error Suppression/Mitigation 1322 may be a program or module capable of performing error suppression or mitigation techniques for improving the reliability of results of quantum computations. Error suppression is the most basic level of error handling. Error suppression refers to techniques where knowledge about the undesirable effects of quantum hardware is used to introduce customization that can anticipate and avoid the potential impacts of those effects, such as modifying signals from Classical-quantum interface 1332 based on the undesirable effects. Error mitigation uses the outputs of ensembles of circuits to reduce or eliminate the effect of noise in estimating expectation values. Error mitigation may include techniques such as Zero Noise Extrapolation (ZNE) and Probabilistic Error Correction (PEC).

Classical computing resource 1323 may be a program or module capable of performing classical (e.g., binary, digital) calculations contained in client application 1311. Classical calculations may include formal logical decisions, AI/ML algorithms, floating point operations, and/or simulation of Quantum operations.

Data store 1324 may be a repository for data to be analyzed using a quantum computing algorithm, as well as the results of such analysis. Data store 1324 may be an implementation of storage 1224 and/or remote database 1230, described in more detail with reference to FIG. 12, configured to operate in a hybrid computing system 1300.

The quantum system 1330 can be any suitable set of components capable of performing quantum operations on a physical system. In various implementations, the quantum system 1330 can be utilized to implement at least a portion of the functionality of the quantum system 201 described above, e.g., with respect to FIGS. 1, 4, and/or 5, and/or other systems. In the example embodiment depicted in FIG. 13, quantum system 1330 includes a local classical controller 1331, a classical-quantum interface 1332, and quantum processor 1333. In some embodiments, all or part of each of the local classical controller 1331, a classical-quantum interface 1332, and quantum processor 1333 may be located in a cryogenic environment to aid in the performance of the quantum operations. In an embodiment, classical backend 1320 and quantum system 1330 may be co-located to reduce the communication latency between the devices.

Local classical controller 1331 may be any combination of classical computing components capable of aiding a quantum computation, such as executing a one or more quantum operations to form a quantum circuit, by providing commands to a classical-quantum interface 1332 as to the type and order of signals to provide to the quantum processor 1333. Local classical controller 1331 may additionally perform other low/no latency functions, such as error correction, to enable efficient quantum computations. Such digital computing devices may include processors and memory for storing and executing quantum commands using classical-quantum interface 1332. Additionally, such digital computing devices may include devices having communication protocols for receiving such commands and sending results of the performed quantum computations to classical backend 1320. Additionally, the digital computing devices may include communications interfaces with the classical-quantum interface 1332. In an embodiment, local classical controller 1331 may include all components of computer 1201, or alternatively may be individual components configured for specific quantum computing functionality, such as processor set 1210, communication fabric 1211, volatile memory 1212, persistent storage 1213, and network module 1215.

Classical-quantum interface 1332 may be any combination of devices capable of receiving command signals from local classical controller 1331 and converting those signals into a format for performing quantum operations on the quantum processor 1333. Such signals may include electrical (e.g., RF, microwave, DC), optical signals, magnetic signals, or vibrational signals to perform one or more single qubit operations (e.g., Pauli gate, Hadamard gate, Phase gate, Identity gate), signals to preform multi-qubit operations (e.g., CNOT-gate, CZ-gate, SWAP gate, Toffoli gate), qubit state readout signals, and any other signals that might enable quantum calculations, quantum error correction, and initiate the readout of a state of a qubit. Additionally, classical-quantum interface 1332 may be capable of converting signals received from the quantum processor 1333 into digital signals capable of processing and transmitting by local classical controller 1331 and classical backend 1320. Such signals may include qubit state readouts. Devices included in classical-quantum interface 1332 may include, but are not limited to, digital-to-analog converters, analog-to-digital converters, waveform generators, attenuators, amplifiers, filters, optical fibers, and lasers. To the above ends, the classical-quantum interface 1332 can include qubit controllers (e.g., qubit controllers 402 as described above with respect to FIGS. 1, 4, 5, and/or 6) and/or other components that facilitate interactions between the local classical controller 1331 and respective qubits associated with the quantum processor 1433, e.g., as described below.

Quantum processor 1333 may be any hardware capable of using quantum states to process information. Such hardware may include a collection of qubits, mechanisms to couple/entangle the qubits, and any required signal routings to communicate between qubits or with classical-quantum interface 1332 in order to process information using the quantum states. Such qubits may include, but are not limited to, charge qubits, flux qubits, phase qubits, spin qubits, and trapped ion qubits, or any other suitable qubit structures. The architecture of quantum processor 1333, such as the arrangement of data qubits, error correcting qubits, and the couplings amongst them, may be a consideration in performing a quantum circuit on quantum processor 1333.

Referring now to FIG. 13B, a block diagram is depicted showing an example architecture, and data transmission, of hybrid computation system 1350 employed using a cloud architecture for classical backend 1320. Hybrid computation system 1350 receives an algorithm containing a computation from a client application 1311 of client device 1310. Upon receipt of the algorithm and request from client application 1311, hybrid computation system 1350 instantiates a classical computing node 1360 and a quantum computing node 1370 to manage the parallel computations. The classical computing node 1360 may include one or more classical computers capable of working in tandem (e.g., utilizing a cloud computing environment). For example, classical computing node 1360 may include an execution orchestration engine 1361, one or more classical computation resources 1323, and a result data store 1324. The backend quantum runtime system 1302 may include a combination of classical and quantum computing components acting together to perform quantum calculations on quantum hardware including, for example, one or more quantum systems 1330. The quantum computing node 1370 may include a quantum runtime application 1371 and one or more quantum systems 1330.

The client application 1311 may include programing instructions to perform quantum and classical calculations. In an embodiment, client application 1311 may be in a general purpose computing language, such as an object oriented computing language (e.g., Python®), that may include classical and quantum functions and function calls. This may enable developers to operate in environments they are comfortable with, thereby enabling a lower barrier of adoption for quantum computation.

The execution orchestration engine 1361, in using algorithm preparation 1321, may parse the client application 1311 into a quantum logic/operations portion for implementation on a quantum computing node 1370, and a classical logic/operations portion for implementation on a classical node 1360 using a classical computation resource 1323. In an embodiment, parsing the client application 1311 may include performing one or more data processing steps prior to operating the quantum logic using the processed data. In an embodiment, parsing the client application 1311 may including segmenting a quantum circuit into portions that are capable of being processed by quantum computing node 1370, in which the partial results of each of the segmented quantum circuits may be recombined as a result to the quantum circuit. Execution orchestration engine 1361 may parse the hybrid algorithm such that a portion of the algorithm is performed using classical computation resources 1323 and a session of quantum computing node 1370 may open to perform a portion of the algorithm. Quantum runtime application 1371 may communicate, directly or indirectly, with classical computation resources 1323 by sending parameters/information between the session to perform parallel calculations and generate/update instructions of quantum assembly language to operate quantum system 1330, and receiving parameters/information/results from the session on the quantum system 1330. Following the parsing of the hybrid algorithm for calculation on quantum computing node 1370 and classical computing node 1360, the parallel nodes may iterate the session to convergence by passing the results of quantum circuits, or partial quantum circuits, performed on quantum system 1330 to classical computing resource 1323 for further calculations. Additionally, runtime application 1371, using algorithm preparation 1321, may re-parse aspects of the hybrid algorithm to improve convergence or accuracy of the result. Such operation results, and progress of convergence, may be sent back to client device 1310 as the operations are being performed. By operating execution orchestration engine 1361 in a cloud environment, the environment may scale (e.g., use additional computers to perform operations necessary) as required by the client application 1311 without any input from the creators/implementors of client application 1311. Additionally, execution orchestration engine 1361, while parsing the client application 1311 into classical and quantum operations, may generate parameters, function calls, or other mechanisms in which classical computation resource 1323 and quantum computing node 1370 may pass information (e.g., data, commands) between the components such that the performance of the computations enabled by client application 1311 is efficient.

Classical computation resources 1323 may perform classical computations (e.g., formal logical decisions, AI/ML algorithms, floating point operations, simulation of Quantum operations) that aid/enable/parallelize the computations instructed by client application 1311. By utilizing classical computation resources 1323 in an adaptively scalable environment, such as a cloud environment, the environment may scale (e.g., use additional computers to perform operations necessary including adding more classical computation resources 1323, additional quantum systems 1330, and/or additional resources of quantum systems 1330 within a given quantum computing node 1370) as required by the client application 1311 without any input from the creators/implementors/developers of client application 1311, and may appear seamless to any individual implementing client application 1311 as there are no required programming instructions in client application 1311 needed to adapt to the classical computation resources 1323. Thus, for example, such scaling of quantum computing resources and classical computing resources may be provided as needed without user intervention. Scaling may reduce the idle time, and thus reduce capacity and management of computers in classical computing node 1360.

Result data store 1324 may store, and return to client device 1310, states, configuration data, etc., as well as the results of the computations of the client application 1311.

Implementation of the systems described herein may enable hybrid computing system 1300, through the use of quantum system 1330, to process information, or solve problems, in a manner not previously capable. The efficient parsing of the quantum or hybrid algorithm into classical and quantum segments for calculation may achieve efficient and accurate quantum calculations from the quantum system 1330 for problems that are exponentially difficult to perform using classical backend 1320. Additionally, the quantum assembly language created by classical backend 1320 may enable quantum system 1330 to use quantum states to perform calculations that are not classically efficient or accurate. Such improvement may reduce the classical resources required to perform the calculation of the quantum or hybrid algorithm, by improving the capabilities of the quantum system 1330.

### Additional Closing Information

The embodiments described herein can be directed to one or more of a system, a method, an apparatus and/or a computer program product at any possible technical detail level of integration. The computer program product can include a computer readable storage medium (or media) having computer readable program instructions thereon for causing a processor to carry out aspects of the one or more embodiments described herein. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a superconducting storage device and/or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon and/or any suitable combination of the foregoing. A computer readable storage medium, as used herein, is not to be construed as being transitory signals per se, such as radio waves and/or other freely propagating electromagnetic waves, electromagnetic waves propagating through a waveguide and/or other transmission media (e.g., light pulses passing through a fiber-optic cable), and/or electrical signals transmitted through a wire.

Computer readable program instructions described herein can be downloaded to respective computing/processing devices from a computer readable storage medium and/or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of the one or more embodiments described herein can be assembler instructions, instruction-set-architecture (ISA) instructions, machine instructions, machine dependent instructions, microcode, firmware instructions, state-setting data, configuration data for integrated circuitry, and/or source code and/or object code written in any combination of one or more programming languages, including an object oriented programming language such as Smalltalk, C++ or the like, and/or procedural programming languages, such as the “C” programming language and/or similar programming languages. The computer readable program instructions can execute entirely on a computer, partly on a computer, as a stand-alone software package, partly on a computer and/or partly on a remote computer or entirely on the remote computer and/or server. In the latter scenario, the remote computer can be connected to a computer through any type of network, including a local area network (LAN) and/or a wide area network (WAN), and/or the connection can be made to an external computer (for example, through the Internet using an Internet Service Provider). In one or more embodiments, electronic circuitry including, for example, programmable logic circuitry, field-programmable gate arrays (FPGA) and/or programmable logic arrays (PLA) can execute the computer readable program instructions by utilizing state information of the computer readable program instructions to personalize the electronic circuitry, in order to perform aspects of the one or more embodiments described herein.

Aspects of the one or more embodiments described herein are described with reference to flowchart illustrations and/or block diagrams of methods, apparatus (systems), and computer program products according to one or more embodiments described herein. It will be understood that each block of the flowchart illustrations and/or block diagrams, and combinations of blocks in the flowchart illustrations and/or block diagrams, can be implemented by computer readable program instructions. These computer readable program instructions can be provided to a processor of a general-purpose computer, special purpose computer and/or other programmable data processing apparatus to produce a machine, such that the instructions, which execute via the processor of the computer or other programmable data processing apparatus, can create means for implementing the functions/acts specified in the flowchart and/or block diagram block or blocks. These computer readable program instructions can also be stored in a computer readable storage medium that can direct a computer, a programmable data processing apparatus and/or other devices to function in a particular manner, such that the computer readable storage medium having instructions stored therein can comprise an article of manufacture including instructions which can implement aspects of the function/act specified in the flowchart and/or block diagram block or blocks. The computer readable program instructions can also be loaded onto a computer, other programmable data processing apparatus and/or other device to cause a series of operational acts to be performed on the computer, other programmable apparatus and/or other device to produce a computer implemented process, such that the instructions which execute on the computer, other programmable apparatus and/or other device implement the functions/acts specified in the flowchart and/or block diagram block or blocks.

The flowcharts and block diagrams in the figures illustrate the architecture, functionality and/or operation of possible implementations of systems, computer-implementable methods and/or computer program products according to one or more embodiments described herein. In this regard, each block in the flowchart or block diagrams can represent a module, segment and/or portion of instructions, which comprises one or more executable instructions for implementing the specified logical function. In one or more alternative implementations, the functions noted in the blocks can occur out of the order noted in the Figures. For example, two blocks shown in succession can be executed substantially concurrently, and/or the blocks can sometimes be executed in the reverse order, depending upon the functionality involved. It will also be noted that each block of the block diagrams and/or flowchart illustration, and/or combinations of blocks in the block diagrams and/or flowchart illustration, can be implemented by special purpose hardware-based systems that can perform the specified functions and/or acts and/or carry out one or more combinations of special purpose hardware and/or computer instructions.

While the subject matter has been described above in the general context of computer-executable instructions of a computer program product that runs on a computer and/or computers, those skilled in the art will recognize that the one or more embodiments herein also can be implemented at least partially in parallel with one or more other program modules. Generally, program modules include routines, programs, components and/or data structures that perform particular tasks and/or implement particular abstract data types. Moreover, the aforedescribed computer-implemented methods can be practiced with other computer system configurations, including single-processor and/or multiprocessor computer systems, mini-computing devices, mainframe computers, as well as computers, hand-held computing devices (e.g., PDA, phone), and/or microprocessor-based or programmable consumer and/or industrial electronics. The illustrated aspects can also be practiced in distributed computing environments in which tasks are performed by remote processing devices that are linked through a communications network. However, one or more, if not all aspects of the one or more embodiments described herein can be practiced on stand-alone computers. In a distributed computing environment, program modules can be located in both local and remote memory storage devices.

As used in this application, the terms “component,” “system,” “platform” and/or “interface” can refer to and/or can include a computer-related entity or an entity related to an operational machine with one or more specific functionalities. The entities described herein can be either hardware, a combination of hardware and software, software, or software in execution. For example, a component can be, but is not limited to being, a process running on a processor, a processor, an object, an executable, a thread of execution, a program and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system and/or across a network such as the Internet with other systems via the signal). As another example, a component can be an apparatus with specific functionality provided by mechanical parts operated by electric or electronic circuitry, which is operated by a software and/or firmware application executed by a processor. In such a case, the processor can be internal and/or external to the apparatus and can execute at least a part of the software and/or firmware application. As yet another example, a component can be an apparatus that provides specific functionality through electronic components without mechanical parts, where the electronic components can include a processor and/or other means to execute software and/or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form. As used herein, the terms “example” and/or “exemplary” are utilized to mean serving as an example, instance, or illustration. For the avoidance of doubt, the subject matter described herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art.

As it is employed in the subject specification, the term “processor” can refer to substantially any computing processing unit and/or device comprising, but not limited to, single-core processors; single-processors with software multithread execution capability; multi-core processors; multi-core processors with software multithread execution capability; multi-core processors with hardware multithread technology; parallel platforms; and/or parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, and/or any combination thereof designed to perform the functions described herein. Further, processors can exploit nano-scale architectures such as, but not limited to, molecular and quantum-dot based transistors, switches and/or gates, in order to optimize space usage and/or to enhance performance of related equipment. A processor can be implemented as a combination of computing processing units.

Herein, terms such as “store,” “storage,” “data store,” data storage,” “database,” and substantially any other information storage component relevant to operation and functionality of a component are utilized to refer to “memory components,” entities embodied in a “memory,” or components comprising a memory. Memory and/or memory components described herein can be either volatile memory or nonvolatile memory or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory and/or nonvolatile random-access memory (RAM) (e.g., ferroelectric RAM (FeRAM). Volatile memory can include RAM, which can act as external cache memory, for example. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM) and/or Rambus dynamic RAM (RDRAM). Additionally, the described memory components of systems and/or computer-implemented methods herein are intended to include, without being limited to including, these and/or any other suitable types of memory.

What has been described above includes mere examples of systems and computer-implemented methods. It is, of course, not possible to describe every conceivable combination of components and/or computer-implemented methods for purposes of describing the one or more embodiments, but one of ordinary skill in the art can recognize that many further combinations and/or permutations of the one or more embodiments are possible. Furthermore, to the extent that the terms “includes,” “has,” “possesses,” and the like are used in the detailed description, claims, appendices and/or drawings such terms are intended to be inclusive in a manner similar to the term “comprising” as “comprising” is interpreted when employed as a transitional word in a claim.

The descriptions of the various embodiments have been presented for purposes of illustration but are not intended to be exhaustive or limited to the embodiments described herein. Many modifications and variations will be apparent to those of ordinary skill in the art without departing from the scope and spirit of the described embodiments. The terminology used herein was chosen to best explain the principles of the embodiments, the practical application and/or technical improvement over technologies found in the marketplace, and/or to enable others of ordinary skill in the art to understand the embodiments described herein.

What is claimed is:

1. A system, comprising:
a memory that stores computer executable components; and
a processor that executes the computer executable components stored in the memory, wherein the computer executable components comprise:
an orchestration component that determines selected real-time control sequences for synchronized execution by qubit controllers; and
a synchronization component that communicates a control message to the qubit controllers, wherein the control message causes the qubit controllers to wait until a common action time and to execute the selected real-time control sequences at the common action time.

2. The system of claim 1, wherein the control message comprises address data indicative of locations within block tables associated with the qubit controllers at which instructions associated with the selected real-time control sequences are stored.

3. The system of claim 2, wherein the address data comprises indexes of entries in jump tables associated with the qubit controllers, and wherein the entries in the jump tables facilitate redirection to the locations within the block tables.

4. The system of claim 1, wherein the selected real-time control sequences comprise first instructions that facilitate applying a stimulus to an associated qubit and second instructions that facilitate measuring a property of the associated qubit resulting from application of the stimulus.

5. The system of claim 1, wherein:
the selected real-time control sequences are first selected real-time control sequences,
the common action time is a first common action time,
the control message is a first control message,
the orchestration component further determines second selected real-time control sequences for synchronized execution by the qubit controllers at a second common action time, the second common action time being a completion time of the first selected real-time control sequences, and
the synchronization component further communicates a second control message to the qubit controllers, wherein the second control message causes the qubit controllers to execute the second selected real-time control sequences at the second common action time.

6. The system of claim 1, wherein the common action time is based on a shared clock signal utilized by the system and the qubit controllers.

7. A computer-implemented method, comprising:
determining, by a system operatively coupled to a processor, selected real-time control sequences for synchronized execution by qubit controllers; and
communicating, by the system, a control message to the qubit controllers, wherein the control message causes the qubit controllers to wait until a common action time and to execute the selected real-time control sequences at the common action time.

8. The computer-implemented method of claim 7, wherein the control message comprises address data indicative of locations within block tables associated with the qubit controllers at which instructions associated with the selected real-time control sequences are stored.

9. The computer-implemented method of claim 8, wherein the address data comprises indexes of entries in jump tables associated with the qubit controllers, and wherein the entries in the jump tables facilitate redirection to the locations within the block tables.

10. The computer-implemented method of claim 7, wherein the selected real-time control sequences are first selected real-time control sequences, wherein the common action time is a first common action time, wherein the control message is a first control message, and wherein the computer-implemented method further comprises:
determining, by the system, second selected real-time control sequences for synchronized execution by the qubit controllers at a second common action time, the second common action time being a completion time of the first selected real-time control sequences, and communicating, by the system, a second control message to the qubit controllers, wherein the second control message causes the qubit controllers to execute the second selected real-time control sequences at the second common action time.

11. The computer-implemented method of claim 7, wherein the common action time is based on a shared clock signal utilized by the system and the qubit controllers.

12. A computer program product facilitating a process to provide low-latency unstructured control flow in a quantum computer, the computer program product comprising a computer readable storage medium having program instructions embodied therewith, the program instructions executable by a processor to cause the processor to:
determine, by the processor, selected real-time control sequences for synchronized execution by qubit controllers; and
communicate, by the processor, a control message to the qubit controllers, wherein the control message causes the qubit controllers to wait until a common action time and to execute the selected real-time control sequences at the common action time.

13. The computer program product of claim 12, wherein the control message comprises address data indicative of locations within block tables associated with the qubit controllers at which instructions associated with the selected real-time control sequences are stored.

14. The computer program product of claim 13, wherein the address data comprises indexes of entries in jump tables associated with the qubit controllers, and wherein the entries in the jump tables facilitate redirection to the locations within the block tables.

15. The computer program product of claim 12, wherein the selected real-time control sequences are first selected real-time control sequences, wherein the common action time is a first common action time, wherein the control message is a first control message, and wherein the program instructions are further executable by the processor to cause the processor to:
determine, by the processor, second selected real-time control sequences for synchronized execution by the qubit controllers at a second common action time, the second common action time being a completion time of the first selected real-time control sequences, and
communicate, by the processor, a second control message to the qubit controllers, wherein the second control message causes the qubit controllers to execute the second selected real-time control sequences at the second common action time.

16. The computer program product of claim 12, wherein the common action time is based on a shared clock signal utilized by the processor and the qubit controllers.

17. A system, comprising:
a memory that stores computer executable components; and
a processor that executes the computer executable components stored in the memory, wherein the computer executable components comprise:
a staging component that locates a real-time qubit control sequence within a block table associated with the system based on addressing information provided in a message received from a remote controller device at a first time; and
a control component that executes the real-time qubit control sequence on quantum hardware at a second time given by the message,
wherein the second time is after the first time, and wherein the first time and the second time are based on a common clock signal that is common to the system and the remote controller device.

18. The system of claim 17, wherein the addressing information comprises an index of an entry of a jump table associated with the system, the entry of the jump table indicating a location of the real-time qubit control sequence within the block table.

19. The system of claim 17, wherein the real-time qubit control sequence comprises instructions that facilitate queueing a signal communication sequence, the signal communication sequence comprising applying a stimulus to a qubit associated with the quantum hardware and measuring a property of the qubit resulting from application of the stimulus.

20. The system of claim 19, wherein the computer executable components further comprise:
a reporting component that transmits information relating to the property of the qubit resulting from the application of the stimulus to the remote controller device.

21. The system of claim 17, wherein:
the real-time qubit control sequence is a first real-time qubit control sequence,
the addressing information is first addressing information,
the message is a first message,
the staging component locates a second real-time qubit control sequence within the block table based on second addressing information provided in a second message received from the remote controller device, and
the control component executes the second real-time qubit control sequence on the associated quantum hardware at a third time given by the second message, the third time being a time at which the control component completes execution of the first real-time qubit control sequence.

22. A computer-implemented method, comprising:
locating, by a system operatively coupled to a processor, a real-time qubit control sequence within a block table associated with the system based on addressing information provided in a message received from a remote controller device at a first time; and
executing, by the system, the real-time qubit control sequence on quantum hardware at a second time given by the message,
wherein the second time is after the first time, and wherein the first time and the second time are based on a common clock signal that is common to the system and the remote controller device.

23. The computer-implemented method of claim 22, wherein the real-time qubit control sequence comprises instructions that facilitate queueing a signal communication sequence, the signal communication sequence comprising applying a stimulus to a qubit associated with the quantum hardware and measuring a property of the qubit resulting from application of the stimulus.

24. The computer-implemented method of claim 23, further comprising:
transmitting, by the system, information relating to the property of the qubit resulting from the application of the stimulus to the remote controller device.

25. The computer-implemented method of claim 22, wherein the real-time qubit control sequence is a first real-time qubit control sequence, wherein the addressing information is first addressing information, wherein the message is a first message, and wherein the computer-implemented method further comprises:
locating, by the system, a second real-time qubit control sequence within the block table based on second addressing information provided in a second message received from the remote controller device; and
executing, by the system, the second real-time qubit control sequence on the associated quantum hardware at a third time given by the second message, the third time being a time at which the system completes execution of the first real-time qubit control sequence.
